(19) United States
(12) Patent Application Publication
(10) Pub. No.: US 2021/0304107 A1
(43) Pub. Date: Sep. 30, 2021

(54) EMPLOYEE PERFORMANCE MONITORING AND ANALYSIS

(71) Applicant: SalesRT LLC, Sheridan, WY (US)

(72) Inventor: Alexander Fink, Austin, TX (US)

(21) Appl. No.: 16/831,416

(22) Filed: Mar. 26, 2020

(51) Int. Cl. G06Q 10/06; G10L 15/26; G10L 17/00

(52) U.S. Cl. CPC G06Q 10/06398; G10L 17/005; G10L 15/265

(57) ABSTRACT

A system includes an audio input device, a transmitter device, a gateway device and a server computer. The audio input device may be configured to capture audio. The transmitter device may be configured to receive the audio from the audio input device and wirelessly communicate the audio. The gateway device may be configured to receive the audio from the transmitter device and generate an audio stream in response to pre-processing the audio. The server computer may be configured to receive the audio stream, execute computer readable instructions that implement an audio processing engine and make a report available in response to the audio stream. The audio processing engine may be configured to distinguish between a plurality of voices of the audio stream, convert the plurality of voices into a text transcript, perform analytics on the audio stream to determine metrics and generate the report based on the metrics.

### FIELD OF THE INVENTION

The invention relates to audio analysis generally and, more particularly, to a method and/or apparatus for implementing employee performance monitoring and analysis.

### BACKGROUND

Many organizations rely on sales and customer service personnel to interact with customers in order to achieve desired business outcomes. For sales personnel, a desired business outcome might consist of successfully closing sale or upselling a customer. For customer service personnel, a desired business outcome might consist of successfully resolving a complaint or customer issue. For a debt collector, a desired business outcome might be collecting a debt. While organizations attempt to provide a consistent customer experience, each employee is an individual that interacts with customers in different ways, has different strengths and different weaknesses. In some organizations employees are encouraged to follow a script, or a specific set of guidelines on how to direct a conversation, how to respond to common objections, etc. Not all employees follow the script, which can be beneficial or detrimental to achieving the desired business outcome.

Personnel can be trained to achieve the desired business outcome more efficiently. Particular individuals in every organization will outperform others on occasion, or consistently. At present, to understand what makes certain employees perform better than others involves observation of each employees. Observation can be direct observation (i.e., in-person), or asking employees for self-reported feedback. Various low-tech methods are currently used to observe employees such as shadowing (i.e., a manager or a senior associate listens in on a conversation that a junior associate is having with customers), secret shoppers (i.e., where an outside company is hired to send undercover people to interact with employees), using hidden camera, etc. However, the low-tech methods are expensive and deliver very partial information. Each method is imprecise and time-consuming.

It would be desirable to implement employee performance monitoring and analysis.

### SUMMARY

The invention concerns a system comprising an audio input device, a transmitter device, a gateway device and a server computer. The audio input device may be configured to capture audio. The transmitter device may be configured to receive the audio from the audio input device and wirelessly communicate the audio. The gateway device may be configured to receive the audio from the transmitter device, perform pre-processing on the audio and generate an audio stream in response to pre-processing the audio. The server computer may be configured to receive the audio stream and comprise a processor and a memory configured to: execute computer readable instructions that implement an audio processing engine and make a curated report available in response to the audio stream. The audio processing engine may be configured to distinguish between a plurality of voices of the audio stream, convert the plurality of voices into a text transcript, perform analytics on the audio stream to determine metrics and generate the curated report based on the metrics.

### BRIEF DESCRIPTION OF THE FIGURES

Embodiments of the invention will be apparent from the following detailed description and the appended claims and drawings.

FIG. 1 is a block diagram illustrating an example embodiment of the present invention.

FIG. 2 is a diagram illustrating employees wearing a transmitter device that connects to a gateway device.

FIG. 3 is a diagram illustrating employees wearing a transmitter device that connects to a server.

FIG. 4 is a diagram illustrating an example implementation of the present invention implemented in a retail store environment.

FIG. 5 is a diagram illustrating an example conversation between a customer and an employee.

FIG. 6 is a diagram illustrating operations performed by the audio processing engine.

FIG. 7 is a diagram illustrating operations performed by the audio processing engine.

FIG. 8 is a block diagram illustrating generating reports.

FIG. 9 is a diagram illustrating a web-based interface for viewing reports.

FIG. 10 is a diagram illustrating an example representation of a sync file and a sales log.

FIG. 11 is a diagram illustrating example reports generated in response sentiment analysis performed by an audio processing engine.

FIG. 12 is a flow diagram illustrating a method for generating reports in response to audio analysis.

FIG. 13 is a flow diagram illustrating a method for performing audio analysis.

FIG. 14 is a flow diagram illustrating a method for determining metrics in response to voice analysis.

### DETAILED DESCRIPTION OF THE EMBODIMENTS

Embodiments of the present invention include providing employee performance monitoring and analysis that may (i) record employee interactions with customers, (ii) transcribe audio, (iii) monitor employee performance, (iv) perform multiple types of analytics on recorded audio, (v) implement artificial intelligence models for assessing employee performance, (vi) enable human analysis, (vii) compare employee conversations to a script for employees, (viii) generate employee reports, (ix) determine tendencies of high-performing employees and/or (x) be implemented as one or more integrated circuits.

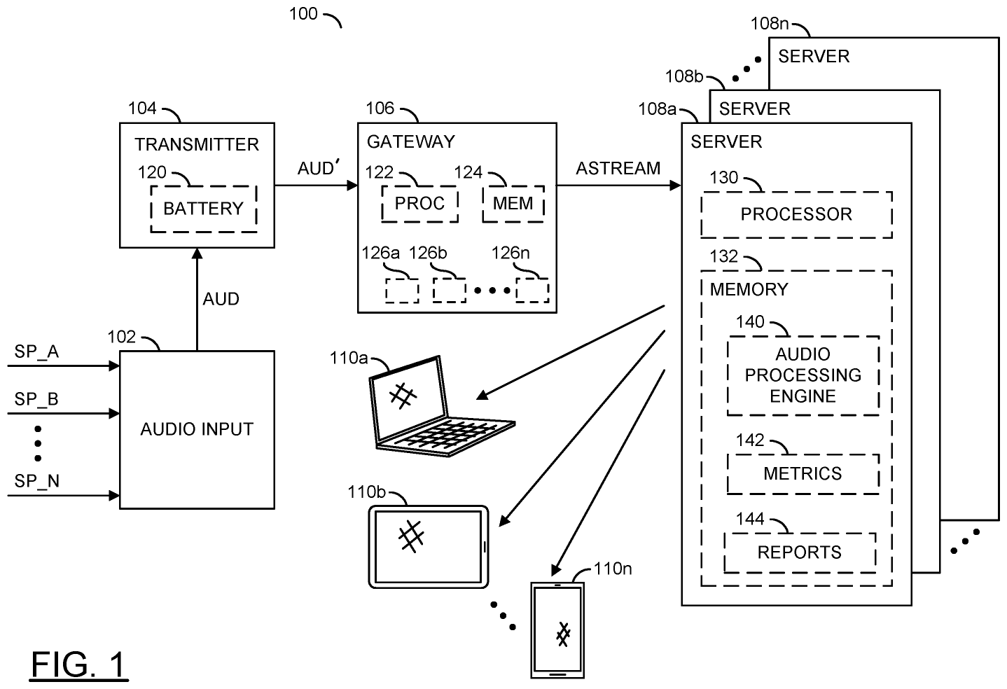

Referring to FIG. 1, a block diagram illustrating an example embodiment of the present invention is shown. A system 100 is shown. The system 100 may be configured to automatically record and/or analyze employee interactions with customers. The system 100 may be configured to generate data that may be used to analyze and/or explain a performance differential between employees. In an example, the system 100 may be implemented by a customer-facing organization and/or business.

The system 100 may be configured to monitor employee performance by recording audio of customer interactions, analyzing the recorded audio, and comparing the analysis to various employee performance metrics. In one example, the system 100 may generate data that may determine a connection between a performance of an employee (e.g., a desired outcome such as a successful sale, resolving a customer complaint, upselling a service, etc.) and an adherence by the employee to a script and/or guidelines provided by the business for customer interactions. In another example, the system 100 may be configured to generate data that may indicate an effectiveness of one script and/or guideline compared to another script and/or guideline. In yet another example, the system 100 may generate data that may identify deviations from a script and/or guideline that result in an employee outperforming other employees that use the script and/or guideline. The type of data generated by the system 100 may be varied according to the design criteria of a particular implementation.

Using the system 100 may enable an organization to train employees to improve performance over time. The data generated by the system 100 may be used to guide employees to use tactics that are used by the best performing employees in the organization. The best performing employees in an organization may use the data generated by the system 100 to determine effects of new and/or alternate tactics (e.g., continuous experimentation) to find new ways to improve performance. The new tactics that improve performance may be analyzed by the system 100 to generate data that may be analyzed and deconstructed for all other employees to emulate.

The system 100 may comprise a block (or circuit) 102, a block (or circuit) 104, a block (or circuit) 106, blocks (or circuits) 108a-108n and/or blocks (or circuits) 110a-110n. The circuit 102 may implement an audio input device (e.g., a microphone). The circuit 104 may implement a transmitter. The block 106 may implement a gateway device. The blocks 108a-108n may implement server computers. The blocks 110a-110n may implement user computing devices. The system 100 may comprise other components and/or multiple implementations of the circuits 102-106 (not shown). The number, type and/or arrangement of the components of the system 100 may be varied according to the design criteria of a particular implementation.

The audio input device 102 may be configured to capture audio. The audio input device 102 may receive one or more signals (e.g., SP_A-SP_N). The signals SP_A-SP_N may comprise incoming audio waveforms. In an example, the signals SP_A-SP_N may represent spoken words from multiple different people. The audio input device 102 may generate a signal (e.g., AUD). The audio input device 102 may be configured to convert the signals SP_A-SP_N to the electronic signal AUD. The signal AUD may be presented to the transmitter device 104.

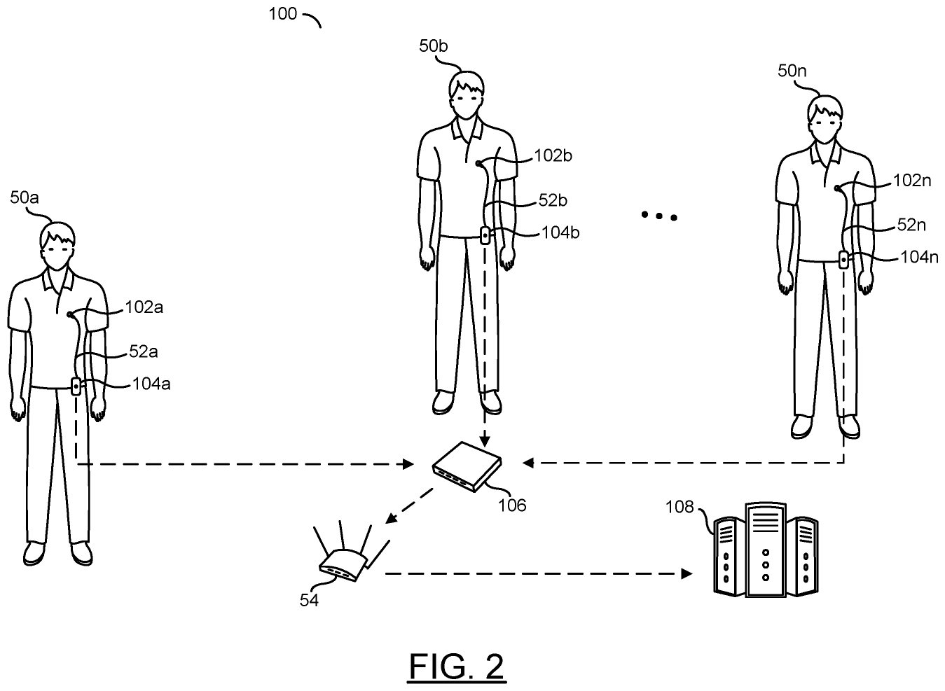

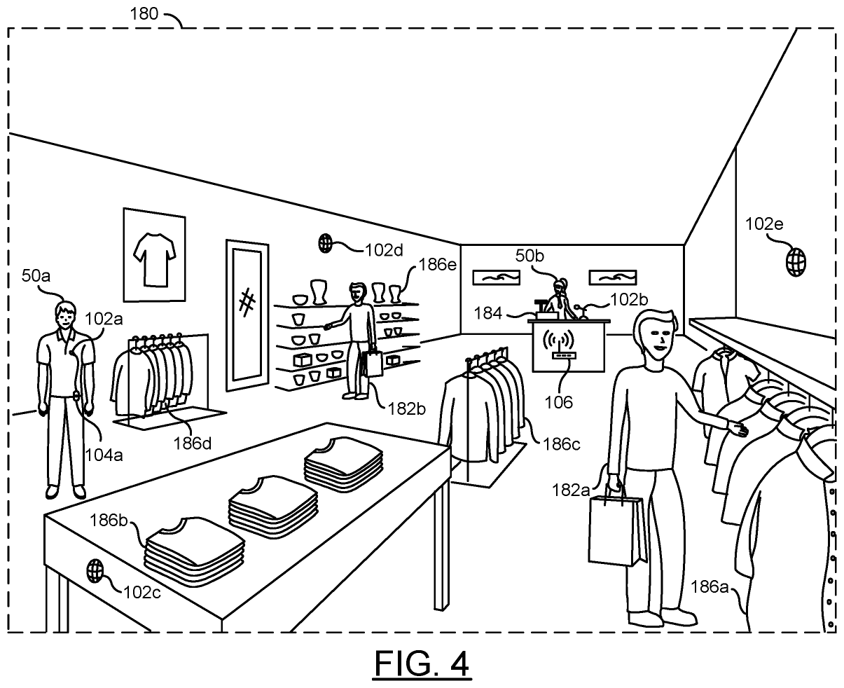

The audio input device 102 may be a microphone. In an example, the audio input device 102 may be a microphone mounted at a central location that may capture the audio input SP_A-SP_N from multiple sources (e.g., an omnidirectional microphone). In another example, the audio input SP_A-SP_N may each be captured using one or more microphones such as headsets or lapel microphones (e.g., separately worn microphones 102a-102n to be described in more detail in association with FIG. 2). In yet another example, the audio input SP_A-SP_N may be captured by using an array of microphones located throughout an area (e.g., separately located microphones 102a-102n to be described in more detail in association with FIG. 4). The type and/or number of instances of the audio input device 102 implemented may be varied according to the design criteria of a particular implementation.

The transmitter 104 may be configured to receive audio from the audio input device 102 and forward the audio to the gateway device 106. The transmitter 104 may receive the signal AUD from the audio input device 102. The transmitter 104 may generate a signal (e.g., AUD′). The signal AUD′ may generally be similar to the signal AUD. For example, the signal AUD may be transmitted from the audio input 102 to the transmitter 104 using a short-run cable and the signal AUD′ may be a re-packaged and/or re-transmitted version of the signal AUD communicated wirelessly to the gateway device 106. While one transmitter 104 is shown, multiple transmitters (e.g., 104a-104n to be described in more detail in association with FIG. 2) may be implemented.

In one example, the transmitter 104 may communicate as a radio-frequency (RF) transmitter. In another example, the transmitter 104 may communicate using Wi-Fi. In yet another example, the transmitter 104 may communicate using other wireless communication protocols (e.g., ZigBee, Bluetooth, LoRa, 4G/HSPA/WiMAX, 5G, SMS, LTE_M, NB-IoT, etc.). In some embodiments, the transmitter 104 may communicate with the servers 108a-108n (e.g., without first accessing the gateway device 106).

The transmitter 104 may comprise a block (or circuit) 120. The circuit 120 may implement a battery. The battery 120 may be configured to provide a power supply to the transmitter 104. The battery 120 may enable the transmitter 104 to be a portable device. In one example, the transmitter 104 may be worn (e.g., clipped to a belt) by employees. Implementing the battery 120 as a component of the transmitter 104 may enable the battery 120 to provide power to the audio input device 102. The transmitter 104 may have a larger size than the audio input device 102 (e.g., a large headset or a large lapel microphone may be cumbersome to wear) to allow for installation of a larger capacity battery. For example, implementing the battery 120 as a component of the transmitter 104 may enable the battery 120 to last several shifts (e.g., an entire work week) of transmitting the signal AUD′ non-stop.

In some embodiments, the battery 120 may be built into the transmitter 104. For example, the battery 120 may be a rechargeable and non-removable battery (e.g., charged via a USB input). In some embodiments, the transmitter 104 may comprise a compartment for the battery 120 to enable the battery 120 to be replaced. In some embodiments, the transmitter 104 may be configured to implement inductive charging of the battery 120. The type of the battery 120 implemented and/or the how the battery 120 is recharged/replaced may be varied according to the design criteria of a particular implementation.

The gateway device 106 may be configured to receive the signal AUD′ from the transmitter 104. The gateway device 106 may be configured to generate a signal (e.g., ASTREAM). The signal ASTREAM may be communicated to the servers 108a-108n. In some embodiments, the gateway device 106 may communicate to a local area network to local servers 108a-108n. In some embodiments, the gateway device 106 may communicate to a wide area network to internet-connected servers 108a-108n.

The gateway device 106 may comprise a block (or circuit) 122, a block (or circuit) 124 and/or blocks (or circuits) 126a-126n. The circuit 122 may implement a processor. The circuit 124 may implement a memory. The circuits 126a-126n may implement receivers. The processor 122 and the memory 124 may be configured to perform audio pre-processing. In an example, the gateway device 106 may be configured as a set-top box, a tablet computing device, a small form-factor computer, etc. The pre-processing of the audio signal AUD′ may convert the audio signal to the audio stream ASTREAM. The processor 122 and/or the memory 124 may be configured to packetize the signal AUD′ for streaming and/or perform compression on the audio signal AUD′ to generate the signal ASTREAM. The type of pre-processing performed to generate the signal ASTREAM may be varied according to the design criteria of a particular implementation.

The receivers 126a-126n may be configured as RF receivers. The RF receivers 126a-126n may enable the gateway device 106 to receive the signal AUD′ from the transmitter device 104. In one example, the RF receivers 126a-126n may be internal components of the gateway device 106. In another example, the RF receivers 126a-126n may be components connected to the gateway device 106 (e.g., connected via USB ports).

The servers 108a-108n may be configured to receive the audio stream signal ASTREAM. The servers 108a-108n may be configured to analyze the audio stream ASTREAM and generate reports based on the received audio. The reports may be stored by the servers 108a-108n and accessed using the user computing devices 110a-110n.

The servers 108a-108n may be configured to store data, retrieve and transmit stored data, process data and/or communicate with other devices. In an example, the servers 108a-108n may be implemented using a cluster of computing devices. The servers 108a-108n may be implemented as part of a cloud computing platform (e.g., distributed computing). In an example, the servers 108a-108n may be implemented as a group of cloud-based, scalable server computers. By implementing a number of scalable servers, additional resources (e.g., power, processing capability, memory, etc.) may be available to process and/or store variable amounts of data. For example, the servers 108a-108n may be configured to scale (e.g., provision resources) based on demand. In some embodiments, the servers 108a-108n may be used for computing and/or storage of data for the system 100 and additional (e.g., unrelated) services. The servers 108a-108n may implement scalable computing (e.g., cloud computing). The scalable computing may be available as a service to allow access to processing and/or storage resources without having to build infrastructure (e.g., the provider of the system 100 may not have to build the infrastructure of the servers 108a-108n).

The servers 108a-108n may comprise a block (or circuit) 130 and/or a block (or circuit) 132. The circuit 130 may implement a processor. The circuit 132 may implement a memory. Each of the servers 108a-108n may comprise an implementation of the processor 130 and the memory 132. Each of the servers 108a-108n may comprise other components (not shown). The number, type and/or arrangement of the components of the servers 108a-108n may be varied according to the design criteria of a particular implementation.

The memory 132 may comprise a block (or circuit) 140, a block (or circuit) 142 and/or a block (or circuit) 144. The block 140 may represent storage of an audio processing engine. The block 142 may represent storage of metrics. The block 144 may represent storage reports. The memory 132 may store other data (not shown).

The audio processing engine 140 may comprise computer executable instructions. The processor 130 may be configured to read the computer executable instructions for the audio processing engine 140 to perform a number of steps. The audio processing engine 140 may be configured to enable the processor 130 to perform an analysis of the audio data in the audio stream ASTREAM.

In one example, the audio processing engine 140 may be configured to transcribe the audio in the audio stream ASTREAM (e.g., perform a speech-to-text conversion). In another example, the audio processing engine 140 may be configured to diarize the audio in the audio stream ASTREAM (e.g., distinguish audio between multiple speakers captured in the same audio input). In yet another example, the audio processing engine 140 may be configured to perform voice recognition on the audio stream ASTREAM (e.g., identify a speaker in the audio input as a particular person). In still another example, the audio processing engine 140 may be configured to perform keyword detection on the audio stream ASTREAM (e.g., identify particular words that may correspond to a desired business outcome). In another example, the audio processing engine 140 may be configured to perform a sentiment analysis on the audio stream ASTREAM (e.g., determine how the person conveying information might be perceived when speaking such as polite, positive, angry, offensive, etc.). In still another example, the audio processing engine 140 may be configured to perform script adherence analysis on the audio stream ASTREAM (e.g., determine how closely the audio matches an employee script). The types of operations performed using the audio processing engine 140 may be varied according to the design criteria of a particular implementation.

The metrics 142 may store business information. The business information stored in the metrics 142 may indicate desired outcomes for the employee interaction. In an example, the metrics 142 may comprise a number of sales (e.g., a desired outcome) performed by each employee. In another example, the metrics 142 may comprise a time that each sale occurred. In yet another example, the metrics 142 may comprise an amount of an upsell (e.g., a desired outcome). The types of metrics 142 stored may be varied according to the design criteria of a particular implementation.

In some embodiments, the metrics 142 may be acquired via input from sources other than the audio input. In one example, if the metrics 142 comprise sales information, the metrics 142 may be received from a cash register at the point of sale. In another example, if the metrics 142 comprise a measure of customer satisfaction, the metrics 142 may be received from customer feedback (e.g., a survey). In yet another example, if the metrics 142 comprise a customer subscription, the metrics 142 may be stored when an employee records a customer subscription. In some embodiments, the metrics 142 may be determined based on the results of the audio analysis of the audio ASTREAM. For example, the analysis of the audio may determine when the desired business outcome has occurred (e.g., a customer verbally agreeing to a purchase, a customer thanking support staff for helping with an issue, etc.). Generally, the metrics 142 may comprise some measure of employee performance towards reaching the desired outcomes.

The reports 144 may comprise information generated by the processor 130 in response to performing the audio analysis using the audio processing engine 140. The reports 144 may comprise curated reports that enable an end-user to search for particular data for a particular employee. The processor 130 may be configured to compare results of the analysis of the audio stream ASTREAM to the metrics 142. The processor 130 may determine correlations between the metrics 142 and the results of the analysis of the audio stream ASTREAM by using the audio processing engine 140. The reports 144 may comprise a database of information about each employee and how the communication between each employee and customers affected each employee in reaching the desired business outcomes.

The reports 144 may comprise curated reports. The curated reports 144 may be configured to present data from the analysis to provide insights into the data. The curated reports 144 may be generated by the processor 130 using rules defined in the computer readable instructions of the memory 132. The curation of the reports 144 may be generated automatically as defined by the rules. In one example, the curation of the reports 144 may not involve human curation. In another example, the curation of the reports 144 may comprise some human curation. In some embodiments, the curated reports 144 may be presented according to preferences of an end-user (e.g., the end-user may provide preferences on which data to see, how the data is presented, etc.). The system 100 may generate large amounts of data. The large amounts of data generated may be difficult for the end-user to glean useful information from. By presenting the curated reports 144, the useful information (e.g., how employees are performing, how the performance of each employee affects sales, which employees are performing well, and which employees are not meeting a minimum requirement, etc.) may be visible at a glance. The curated reports 144 may provide options to display more detailed results. The design, layout and/or format of the curated reports 144 may be varied according to the design criteria of a particular implementation.

The curated reports 144 may be searchable and/or filterable. In an example, the reports 144 may comprise statistics about each employee and/or groups of employees (e.g., employees at a particular store, employees in a particular region, etc.). The reports 144 may comprise leaderboards. The leaderboards may enable gamification of reaching particular business outcomes (e.g., ranking sales leaders, ranking most helpful employees, ranking employees most liked by customers, etc.). The reports 144 may be accessible using a web-based interface.

The user computing devices 110a-110n may be configured to communicate with the servers 108a-108n. The user computing devices 110a-110n may be configured to receive input from the servers 108a-108n and receive input from end-users. The user computing devices 110a-110n may comprise desktop computers, laptop computers, notebooks, netbooks, smartphones, tablet computing devices, etc. Generally, the computing devices 110a-110n may be configured to communicate with a network, receive input from an end-user, provide a display output, provide audio output, etc. The user computing devices 110a-110n may be varied according to the design criteria of a particular implementation.

The user computing devices 110a-110n may be configured to upload information to the servers 108a-108n. In one example, the user computing devices 110a-110n may comprise point-of-sales devices (e.g., a cash register), that may upload data to the servers 108a-108n when a sales has been made (e.g., to provide data for the metrics 142). The user computing devices 110a-110n may be configured to download the reports 144 from the servers 108a-108n. The end-users may use the user computing devices 110a-100n to view the curated reports 144 (e.g., using a web-interface, using an app interface, downloading the raw data using an API, etc.). The end-users may comprise business management (e.g., users that are seeking to determine how employees are performing) and/or employees (e.g., users seeking to determine a performance level of themselves).

Referring to FIG. 2, a diagram illustrating employees wearing a transmitter device that connects to a gateway device is shown. An example embodiment of the system 100 is shown. In the example system 100, a number of employees 50a-50n are shown. Each of the employees 50a-50n are shown wearing the audio input devices 102a-102n. Each of the employees 50a-50n are shown wearing one of the transmitters 104a-104n.

In some embodiments, each of the employees 50a-50n may wear one of the audio input devices 102a-102n and one of the transmitters 104a-104n. In the example shown, the audio input devices 102a-102n may be lapel microphones (e.g., clipped to a shirt of the employees 50a-50n near the mouth). The lapel microphones 102a-102n may be configured to capture the voice of the employees 50a-50n and any nearby customers (e.g., the signals SP_A-SP_N).

In the example shown, each of the audio input devices 102a-102n may be connected to the transmitters 104a-104n, respectively by respective wires 52a-52n. The wires 52a-52n may be configured to transmit the signal AUD from the audio input devices 102a-102n to the transmitters 104a-104n. The wires 52a-52n may be further configured to transmit the power supply from the battery 120 of the transmitters 104a-104n to the audio input devices 102a-102n.

The example embodiment of the system 100 shown may further comprise the gateway device 106, the server 108 and/or a router 54. Each of the transmitters 104a-104n may be configured to communicate an instance of the signal AUD′ to the gateway device 106. The gateway device 106 may perform the pre-processing to generate the signal ASTREAM. The signal ASTREAM may be communicated to the router 54.

The router 54 may be configured to communicate with a local network and a wide area network. For example, the router 54 may be configured to connect to the gateway device 106 using the local network (e.g., communications within the store that the system 100 is implemented) and the sever 108 using the wide area network (e.g., an internet connection). The router 54 may be configured to communicate data using various protocols. The router 54 may be configured to communicate using wireless communication (e.g., Wi-Fi) and/or wired communication (e.g., Ethernet). The router 54 may be configured to forward the signal ASTREAM from the gateway device 106 to the server 108. The implementation of the router 54 may be varied according to the design criteria of a particular implementation.

In an example implementation of the system 100, each employee 50a-50n may wear the lapel microphones (or headsets) 102a-102n, which may be connected via the wires 52a-52n to the RF transmitters 104a-104n (e.g., RF, Wi-Fi or any or RF band). The RF receivers 126a-126n may be connected to the gateway device 106 (e.g., a miniaturized computer with multiple USB ports), which may receive the signal AUD′ from the transmitters 104a-104n. The gateway device 106 may pre-process the audio streams, and upload the pre-processed streams to the cloud servers 108a-108n (e.g., via Wi-Fi through the router 54 that may also be present at the business). The data (e.g., provided by the signal ASTREAM) may then be analyzed by the server 108 (e.g., as a cloud service and/or using a private server). The results of the analysis may be sent to the store manager (or other stakeholder) via email and/or updated in real-time on a web/mobile dashboard interface.

In some embodiments, the microphones 102a-102n and the transmitters 104a-104n may be combined into a single device that may be worn (e.g., a headset). Constraints of the battery 120 may cause a combined headset/transmitter to be too large to be conveniently worn by the employees 50a-50n and enable the battery 120 to last for hours (e.g., the length of a shift of a salesperson). Implementing the headsets 102a-102n connected to the transmitters 104a-104n using the wires 52a-52n (e.g., a regular audio cable with a 3.5 mm connector) may allow for a larger size of the battery 120. For example, if the transmitters 104a-104n are worn on a belt of the employees 50a-50n, a larger battery 120 may be implemented. A larger battery 120 may enable the transmitters 104a-104n to operate non-stop for several shifts (or an entire work week) for continuous audio transmission. The wires 52a-52n may further be configured to feed power from the battery 120 to the microphones 102a-102n.

In some embodiments, the microphones 102a-102n and the transmitters 104a-104n may be connected to each other via the wires 52a-52n. In some embodiments, the microphones 102a-102n and the transmitters 104a-104n may be physically plugged into one another. For example, the transmitters 104a-104n may comprise a 3.5 mm audio female socket and the microphones 102a-102n may comprise a 3.5 mm audio male connector to enable the microphones 102a-102n to connect directly to the transmitters 104a-104n. In some embodiments, the microphones 102a-102n and the transmitters 104a-104n may be embedded in a single housing (e.g, a single device). In one example, one of the microphones 102a may be embedded in a housing with the transmitter 102a and appear as a wireless microphone (e.g., clipped to a tie). In another example, one of the microphones 102a may be embedded in a housing with the transmitter 102a and appear as a wireless headset (e.g., worn on the head).

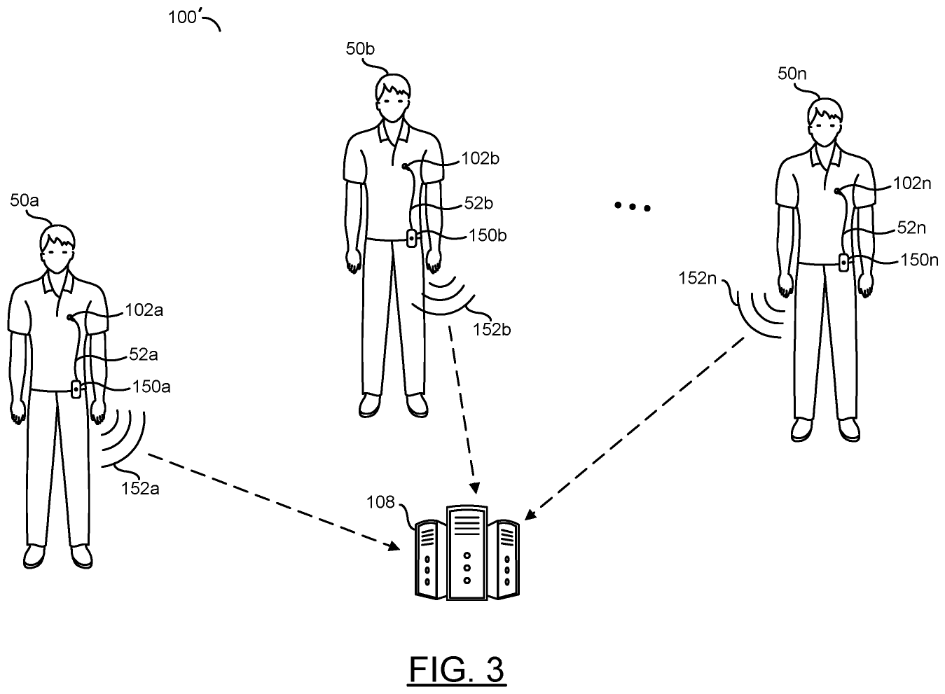

Referring to FIG. 3, a diagram illustrating employees wearing a transmitter device that connects to a server is shown. An alternate example embodiment of the system 100′ is shown. In the example system 100′, the employees 50a-50n are shown. Each of the employees 50a-50n are shown wearing the audio input devices 102a-102n. The wires 52a-52n are shown connecting each of the audio input devices 102a-102n to respective blocks (or circuits) 150a-150n.

The circuits 150a-150n may each implement a communication device. The communication devices 150a-150n may comprise a combination of the transmitters 104a-104n and the gateway device 106. The communication devices 150a-150n may be configured to implement functionality similar to the transmitters 104a-104n and the gateway device 106 (and the router 54). For example, the communication devices 150a-150n may be configured to receive the signal AUD from the audio input devices 102a-102n and provide power to the audio input devices 102a-102n via the cables 52a-52n, perform the preprocessing to generate the signal ASTREAM and communicate with a wide area network to transmit the signal ASTREAM to the server 108.

Curved lines 152a-152n are shown. The curved lines 152a-152n may represent wireless communication performed by the communication devices 150a-150n. The communication devices 150a-150n may be self-powered devices capable of wireless communication. The wireless communication may enable the communication devices 150a-150n to be portable (e.g., worn by the employees 50a-50n). The communication waves 152a-152n may communicate the signal ASTREAM to the internet and/or the server 108.

Referring to FIG. 4, a diagram illustrating an example implementation of the present invention implemented in a retail store environment is shown. A view of a store 180 is shown. A number of the employees 50a-50b are shown in the store 180. A number of customers 182a-182b are shown in the store 180. While two customers 182a-182b are in the example shown, any number of customers (e.g., 182a-182n) may be in the store 180. The employee 50a is shown wearing the lapel mic 50a and the transmitter 104a. The employee 50b is shown near a cash register 184. The microphone 102b and the gateway device 106 are shown near the cash register 184. Merchandise 186a-186e is shown throughout the store 180. The customers 182a-182b are shown near the merchandise 186a-186e.

An employer implementing the system 100 may use various combinations of the types of audio input devices 102a-102n. In the example shown, the employee 50a may have the lapel microphone 102a to capture audio when the employee 50a interacts with the customers 182a-182b. For example, the employee 50a may be an employee on the floor having the job of asking customers if they want help with anything. In an example, the employee 50a may approach the customer 182a at the merchandise 186a and ask, “Can I help you with anything today?” and the lapel microphone 102a may capture the voices of the employee 50a and the customer 182a. In another example, the employee 50a may approach the customer 182b at the merchandise 186e and ask if help is wanted. The portability of the lapel microphone 102a and the transmitter 104a may enable audio corresponding to the employee 50a to be captured by the lapel microphone 102a and transmitted by the transmitter 104a to the gateway device 106 from any location in the store 180.

Other types of audio input devices 102a-102n may be implemented to offer other types of audio capture. The microphone 102b may be mounted near the cash register 184. In some embodiments, the cash register microphone 102b may be implemented as an array of microphones. In one example, the cash register microphone 102b may be a component of a video camera located near the cash register 184. Generally, the customers 182a-182b may finalize purchases at the cash register 184. The mounted microphone 102b may capture the voice of the employee 50b operating the cash register 184 and the voice of the customers 182a-182b as the customers 182a-182b check out. With the mounted microphone 102b in a stationary location near the gateway device 106, the signal AUD may be communicated using a wired connection.

The microphones 102c-102e are shown installed throughout the store 180. In the example shown, the microphone 102c is attached to a table near the merchandise 186b, the microphone 102d is mounted on a wall near the merchandise 186e and the microphone 102e is mounted on a wall near the merchandise 186a. The microphones 102c-102e may enable audio to be captured throughout the store 180 (e.g., to capture all interactions between the employees 50a-50b and the customers 182a-182b). For example, the employee 50b may leave the cash register 184 to talk to the customer 182b. Since the mounted microphone 102b may not be portable, the microphone 102d may be available nearby to capture dialog between the employee 50b and the customer 182b at the location of the merchandise 186e. In some embodiments, the wall-mounted microphones 102c-102e may be implemented as an array of microphones and/or an embedded component of a wall-mounted camera (e.g., configured to capture audio and video).

Implementing the different types of audio input devices 102a-102n throughout the store 180 may enable the system 100 to capture multiple conversations between the employees 50a-50b and the customers 182a-182b. The conversations may be captured simultaneously. In one example, the lapel microphone 102a and the wall microphone 102e may capture a conversation between the employee 50a and the customer 182a, while the wall microphone 102d captures a conversation between the employee 50b and the employee 182b. The audio captured simultaneously may all be transmitted to the gateway device 106 for pre-processing. The pre-processed audio ASTREAM may be communicated by the gateway device 106 to the servers 108a-108n.

In the example of a retail store 180 shown, sales of the merchandise 186a-186e may be the metrics 142. For example, when the customers 182a-182b checkout at the cash register 184, the sales of the merchandise 186a-186e may be recorded and stored as part of the metrics 142. The audio captured by the microphones 102a-102n may be recorded and stored. The audio captured may be compared to the metrics 142. In an example, the audio from a time when the customers 182a-182b check out at the cash register 184 may be used to determine a performance of the employees 50a-50b that resulted in a sale. In another example, the audio from a time before the customers 182a-182b check out may be used to determine a performance of the employees 50a-50b that resulted in a sale (e.g., the employee 50a helping the customer 186a find the clothing in the proper size or recommending a particular style may have led to the sale).

Generally, the primary mode of audio data acquisition may be via omnidirectional lapel-worn microphones (or a full-head headset with an omnidirectional microphone) 102a-102n. For example, a lapel microphone may provide clear audio capture of every conversation the employees 50a-50n are having with the customers 182a-182n. Another example option for audio capture may comprise utilizing multiple directional microphones (e.g., one directional microphone aimed at the mouth of one of the employees 50a-50n and another directional microphone aimed forward towards where the customers 182a-182n are likely to be. A third example option may be the stationary microphone 102b and/or array of microphones mounted on or near the cash register 184 (e.g., in stores where one or more of the employees 50a-50n are usually in one location).

The transmitters 104a-104n may acquire the audio feed AUD from a respective one of the microphones 102a-102n. The transmitters 104a-104n may forward the audio feeds AUD′ to the gateway device 106. The gateway device 106 may perform the pre-processing and communicate the signal ASTREAM to the centralized processing servers 108a-108n where the audio may be analyzed using the audio processing engine 140. The gateway device 106 is shown near the cash register 184 in the store 180. For example, the gateway device 106 may be implemented as a set-top box, a tablet computing device, a miniature computer, etc. In an example, the gateway device 106 may be further configured to operate as the cash register 184. In one example, the gateway device 106 may receive all the audio streams directly. In another example, the RF receivers 126a-126n may be connected as external devices and connected to the gateway device 106 (e.g., receivers connected to USB ports).

Multiple conversations may be occurring throughout the store 180 at the same time. All the captured audio from the salespeople 50a-50n may go through to the gateway device 106. Once the gateway device 106 receives the multiple audio streams AUD′, the gateway device may perform the pre-processing. In response to the pre-processing, the gateway device 106 may provide the signal ASTREAM to the servers 108a-108n. The gateway device 106 may be placed in the physical center of the retail location 180 (e.g., to receive audio from the RF transmitters 104a-104n that travel with the employees 50a-50n throughout the retail location 180). The location of the gateway device 106 may be fixed. Generally, the location of the gateway device 106 may be near a power outlet.

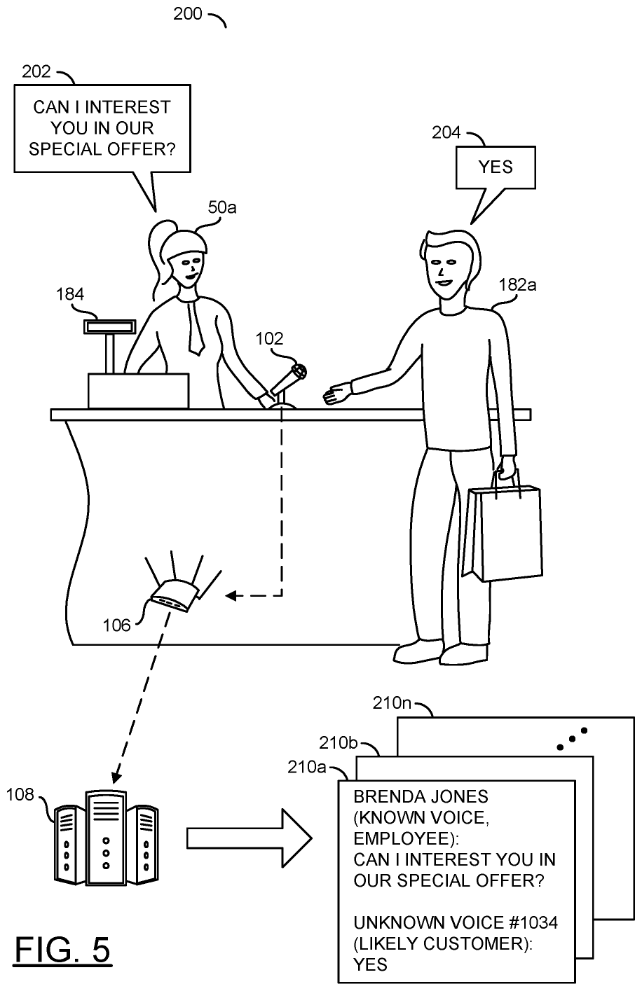

Referring to FIG. 5, a diagram illustrating an example conversation 200 between a customer and an employee is shown. The example conversation 200 may comprise the employee 50a talking with the customer 182a. The employee 50a and the customer 182a may be at the cash register 184 (e.g., paying for a purchase). The microphone 102 may be mounted near the cash register 184. The gateway device 106 may be located in a desk under the cash register 184.

A speech bubble 202 and a speech bubble 204 are shown. The speech bubble 202 may correspond with words spoken by the employee 50a. The speech bubble 204 may correspond with words spoken by the customer 182a. In some embodiments, the microphone 102 may comprise an array of microphones. The array of microphones 102 may be configured to perform beamforming. The beamforming may enable the microphone 102 to direct a polar pattern towards each person talking (e.g., the employee 50a and the customer 182a). The beamforming may enable the microphone 102 to implement noise cancelling. Ambient noise and/or voices from other conversations may be attenuated. For example, since multiple conversations may be occurring throughout the store 180, the microphone 102 may be configured to filter out other conversations in order to capture clear audio of the conversation between the employee 50a and the customer 182a.

In the example shown, the speech bubble 202 may indicate that the employee 50a is asking the customer 182a about a special offer. The special offer in the speech bubble 202 may be an example of an upsell. The upsell may be one of the desired business outcomes that may be used to measure employee performance in the metrics 142. The microphone 102 may capture the speech shown as the speech bubble 202 as an audio input (e.g., the signal SP_A). The microphone 102 (or the transmitter 104, not shown) may communicate the audio input to the gateway device 106 as the signal AUD. The gateway device 106 may perform the pre-processing (e.g., record the audio input as a file, provide a time-stamp, perform filtering, perform compression, etc.).

In the example shown, the speech bubble 204 may indicate that the customer 182a is responding affirmatively to the special offer asked about by the employee 50a. The affirmative response in the speech bubble 204 may be an example of the desired business outcome. The desired business outcome may be used as a positive measure of employee performance in the metrics 142 corresponding to the employee 50a. The microphone 102 may capture the speech shown as the speech bubble 204 as an audio input (e.g., the signal SP_B). The microphone 102 (or the transmitter 104, not shown) may communicate the audio input to the gateway device 106 as the signal AUD. The gateway device 106 may perform the pre-processing (e.g., record the audio input as a file, provide a time-stamp, perform filtering, perform compression, etc.).

The gateway device 106 may communicate the signal ASTREAM to the servers 108. The gateway device 106 may communicate the signal ASTREAM in real time (e.g., continually or continuously capture the audio, perform the pre-processing and then communicate to the servers 108). The gateway device 106 may communicate the signal ASTREAM periodically (e.g., capture the audio, perform the pre-processing and store the audio until a particular time, then upload all stored audio streams to the servers 108). The gateway device 106 may communicate an audio stream comprising the audio from the speech bubble 202 and the speech bubble 204 to the servers 108a-108n for analysis.

The audio processing engine 140 of the servers 108a-108n may be configured to perform data processing on the audio streams. One example operation of the data processing performed by the audio processing engine 140 may be speech-to-text transcription. Blocks 210a-210n are shown generated by the server 108. The blocks 210a-210n may represent text transcriptions of the recorded audio. In the example shown, the text transcription 210a may comprise the text from the speech bubble 202.

The data processing of the audio streams performed by the audio processing engine 140 may perform various operations. The audio processing engine 140 may comprise multiple modules and/or sub-engines. The audio processing engine 140 may be configured to implement a speech-to-text engine to turn audio stream ASTREAM into the transcripts 210a-210n. The audio processing engine 140 may be configured to implement a diarization engine to split and/or identify the transcripts 210a-210n into roles (e.g., speaker 1, speaker 2, speaker 3, etc.). The audio processing engine 140 may be configured to implement a voice recognition engine to correlate roles (e.g., speaker 1, speaker 2, speaker 3, etc.) to known people (e.g., the employees 50a-50n, the customers 182a-182n, etc.)

In the example shown, the transcript 210a shown may be generated in response to the diarization engine and/or the voice recognition engine of the audio processing engine 140. The speech shown in the speech bubble 202 by the employee 50a may be transcribed in the transcript 210a. The speech shown in the speech bubble 204 may be transcribed in the transcript 210a. The diarization engine may parse the speech to recognize that a portion of the text transcript 210a corresponds to a first speaker and another portion of the text transcript 210b corresponds to a second speaker. The voice recognition engine may parse the speech to recognize that the first portion may correspond to a recognized voice. In the example shown, the recognized voice may be identified as ‘Brenda Jones’. The name Brenda Jones may correspond to a known voice of the employee 50a. The voice recognition engine may further parse the speech to recognize that the second portion may correspond to an unknown voice. The voice recognition engine may assign the unknown voice a unique identification number (e.g., unknown voice #1034). The audio processing engine 140 may determine that, based on the context of the conversation, the unknown voice may correspond to a customer.

The data processing of the audio streams performed by the audio processing engine 140 may further perform the analytics. The analytics may be performed by the various modules and/or sub-engines of the audio processing engine 140. The analytics may comprise rule-based analysis and/or analysis using artificial intelligence (e.g., applying various weights to input using a trained artificial intelligence model to determine an output). In one example, the analysis may comprise measuring key performance indicators (KPI) (e.g., the number of the customers 182a-182n each employee 50a spoke with, total idle time, number of sales, etc.). The KPI may be defined by the managers, business owners, stakeholders, etc. In another example, the audio processing engine 140 may perform sentiment analysis (e.g., a measure of politeness, positivity, offensive speech, etc.). In yet another example, the analysis may measure keywords and/or key phrases (e.g., which of a list of keywords and key phrases did the employee 50a mention, in what moments, how many times, etc.). In still another example, the analysis may measure script adherence (e.g., compare what the employee 50a says to pre-defined scripts, highlight deviations from the script, etc.).

In some embodiments, the audio processing engine 140 may be configured to generate a sync data (e.g., a sync file). The audio processing engine 140 may link highlights of the transcripts 210a-210n to specific times in the source audio stream ASTREAM. The sync data may provide the links and the timestamps along with the transcription of the audio. The sync data may be configured to enable a person to conveniently verify the validity of the highlights performed by the audio processing engine 140 by clicking the link and listening to the source audio.

In some embodiments, highlights generated by the audio analytics engine 140 may be provided to the customer as-is (e.g., made available as the reports 144 using a web-interface). In some embodiments, the transcripts 210a-210n, the source audio ASTREAM and the highlights generated by the audio analytics engine 140 may be first sent to human analysts for final analysis and/or post-processing.

In the example shown, the audio processing engine 140 may be configured to compare the metrics 142 to the timestamp of the audio input ASTREAM. For example, the metrics 142 may comprise sales information provided by the cash register 184. The cash register 184 may indicate that the special offer was entered at a particular time (e.g., 4:19 pm on Thursday on a particular date). The audio processing engine 140 may detect that the special offer from the employee 50a and the affirmative response by the customer 182a has a timestamp with the same time as the metrics 142 (e.g., the affirmative response has a timestamp near 4:19 on Thursday on a particular date). The audio processing engine 140 may recognize the voice of the employee 50a, and attribute the sale of the special offer to the employee 50a in the reports 144.

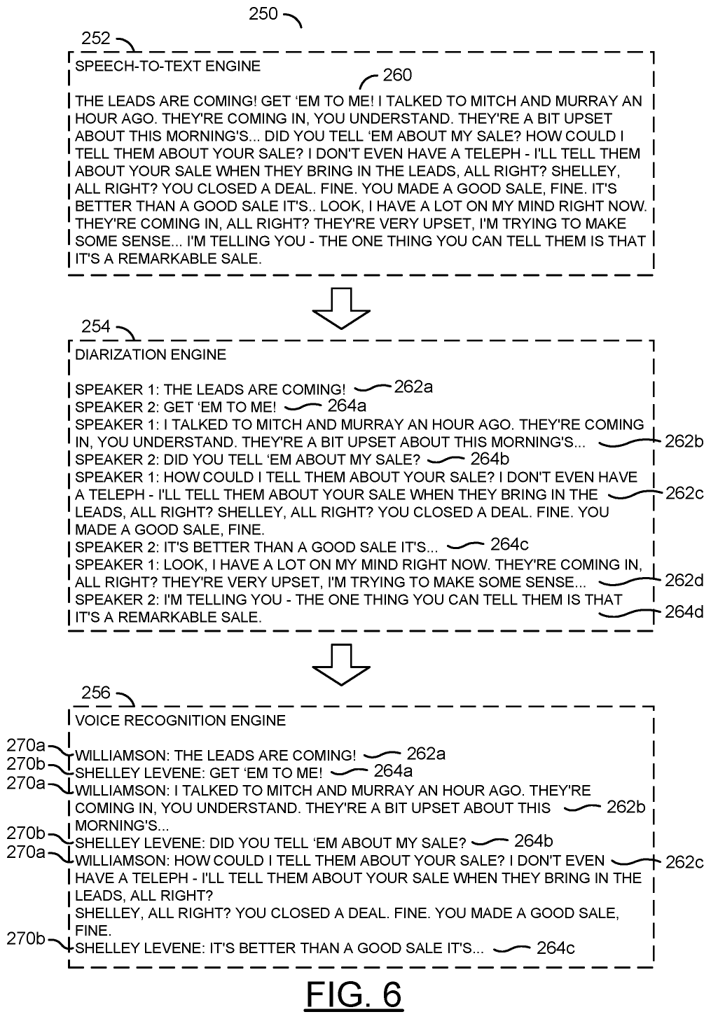

Referring to FIG. 6, a diagram illustrating operations performed by the audio processing engine 140 is shown. An example sequence of operations 250 are shown. The example sequence of operations 250 may be performed by the various modules of the audio processing engine 140. In the example shown, the modules of the audio processing engine 140 used to perform the example sequence of operations 250 may comprise a block (or circuit) 252, a block (or circuit) 254 and/or a block (or circuit) 256. The block 252 may implement a speech-to-text engine. The block 254 may implement a diarization engine. The block 256 may implement a voice recognition engine. The blocks 252-256 may each comprise computer readable instructions that may be executed by the processor 130. The example sequence of operations 250 may be configured to provide various types of data that may be used to generate the reports 144.

Different sequences of operations and/or types of analysis may utilize different engines and/or sub-modules of the audio processing engine 140 (not shown). The audio processing engine 140 may comprise other engines and/or sub-modules. The number and/or types of engines and/or sub-modules implemented by the audio processing engine 140 may be varied according to the design criteria of a particular implementation.

The speech-to-text engine 252 may comprise text 260. The text 260 may be generated in response to the analysis of the audio stream ASTREAM. The speech-to-text engine 252 may analyze the audio in the audio stream ASTREAM, recognize the audio as specific words and generate the text 260 from the specific words. For example, the speech-to-text engine 252 may implement speech recognition. The speech-to-text engine 252 may be configured to perform a transcription to save the audio stream ASTREAM as a text-based file. For example, the text 260 may be saved as the text transcriptions 210a-210n. Most types of analysis performed by the audio processing engine 140 may comprise performing the transcription of the speech-to-text engine 252 and then performing natural language processing on the text 260.

Generally, the text 260 may comprise the words spoken by the employees 50a-50n and/or the customers 182a-182n. In the example shown, the text 260 generated by the speech-to-text engine 252 may not necessarily be attributed to a specific person or identified as being spoken by different people. For example, the speech-to-text engine 252 may provide a raw data dump of the audio input to a text output. The format of the text 260 may be varied according to the design criteria of a particular implementation.

The diarization engine 254 may comprise identified text 262a-262d and/or identified text 264a-264d. The diarization engine 254 may be configured to generate the identified text 262a-262d and/or the identified text 264a-264d in response to analyzing the text 260 generated by the speech-to-text engine 252 and analysis of the input audio stream ASTREAM. In the example shown, the diarization engine 254 may generate the identified text 262a-262d associated with a first speaker and the identified text 264a-264d associated with a second speaker. In an example, the identified text 262a-262d may comprise an identifier (e.g., Speaker 1) to correlate the identified text 262a-262d to the first speaker and the identified text 264a-264d may comprise an identifier (e.g., Speaker 2) to correlate the identified text 264a-264d to the second speaker. However, the number of speakers (e.g., people talking) identified by the diarization engine 254 may be varied according to the number of people that are talking in the audio stream ASTREAM. The identified text 262a-262n and/or the identified text 264a-264n may be saved as the text transcriptions 210a-210n.

The diarization engine 254 may be configured to compare voices (e.g., frequency, pitch, tone, etc.) in the audio stream ASTREAM to distinguish between different people talking. The diarization engine 254 may be configured to partition the audio stream ASTREAM into homogeneous segments. The homogeneous segments may be partitioned according to a speaker identity. In an example, the diarization engine 254 may be configured to identify each voice detected as a particular role (e.g., an employee, a customer, a manager, etc.). The diarization engine 254 may be configured to categorize portions of the text 260 as being spoken by a particular person. In the example shown, the diarization engine 254 may not know specifically who is talking. The diarization engine 254 may identify that one person has spoken the identified text 262a-262d and a different person has spoken the identified text 264a-264d. In the example shown, the diarization engine 254 may identify that two different people are having a conversation and attribute portions of the conversation to each person.

The voice recognition engine 256 may be configured to compare (e.g., frequency, pitch, tone, etc.) known voices (e.g., stored in the memory 132) with voices in the audio stream ASTREAM to identify particular people talking. In some embodiments, the voice recognition engine 256 may be configured to identify particular portions of the text 260 as having been spoken by a known person (e.g., the voice recognition may be performed after the operations performed by the speech-to-text engine 252). In some embodiments, the voice recognition engine 256 may be configured to identify the known person that spoke the identified text 262a-262d and another known person that spoke the identified text 264a-264d (e.g., the voice recognition may be performed after the operations performed by the diarization engine 256). In the example shown, the known person 270a (e.g., a person named Williamson) may be determined by the voice recognition engine 256 as having spoken the identified text 262a-262c and the known person 270b (e.g., a person named Shelley Levene) may be determined by the voice recognition engine 256 as having spoken the identified text 264a-264c. Generally, to identify a known person based on the audio stream ASTREAM, voice data (e.g., audio features extracted from previously analyzed audio of the known person speaking such as frequency, pitch, tone, etc.) corresponding to the known person may be stored in the memory 132 to enable a comparison to the current audio stream ASTREAM. Identifying the particular speaker (e.g., the person 270a-270b) may enable the server 108 to correlate the analysis of the audio stream ASTREAM with a particular one of the employees 50a-50n to generate the reports 144.

The features (e.g., engines and/or sub-modules) of the audio processing engine 140 may be performed by analyzing the audio stream ASTREAM, the text 260 generated from the audio stream ASTREAM and/or a combination of the text 260 and the audio stream ASTREAM. In one example, the diarization engine 254 may operate directly on the audio stream ASTREAM. In another example, the voice recognition engine 256 may operate directly on the audio stream ASTREAM.

The audio processing engine 140 may be further configured to perform MC detection based on the audio from the audio stream ASTREAM. MC detection may comprise determining which of the voices in the audio stream ASTREAM is the person wearing the microphone 102 (e.g., determining that the employee 50a is the person wearing the lapel microphone 102a). The MC detection may be configured to perform segmentation of conversations (e.g., determining when a person wearing the microphone 102 has switched from speaking to one group of people, to speaking to another group of people). The segmentation may indicate that a new conversation has started.

The audio processing engine 140 may be configured to perform various operations using natural language processing. The natural language processing may be analysis performed by the audio processing engine 140 on the text 260 (e.g., operations performed in a domain after the audio stream ASTREAM has been converted into text-based language). In some embodiments, the natural language processing may be enhanced by performing analysis directly on the audio stream ASTREAM. For example, the natural language processing may provide one set of data points and the direct audio analysis may provide another set of data points. The audio processing engine 140 may implement a fusion of analysis from multiple sources of information (e.g., the text 260 and the audio input ASTREAM) for redundancy and/or to provide disparate sources of information. By performing fusion, the audio processing engine 140 may be capable of making inferences about the speech of the employees 50a-50n and/or the customers 182a-182n that may not be possible from one data source alone. For example, sarcasm may not be easily detected from the text 260 alone but may be detected by combining the analysis of the text 260 with the way the words were spoken in the audio stream ASTREAM.

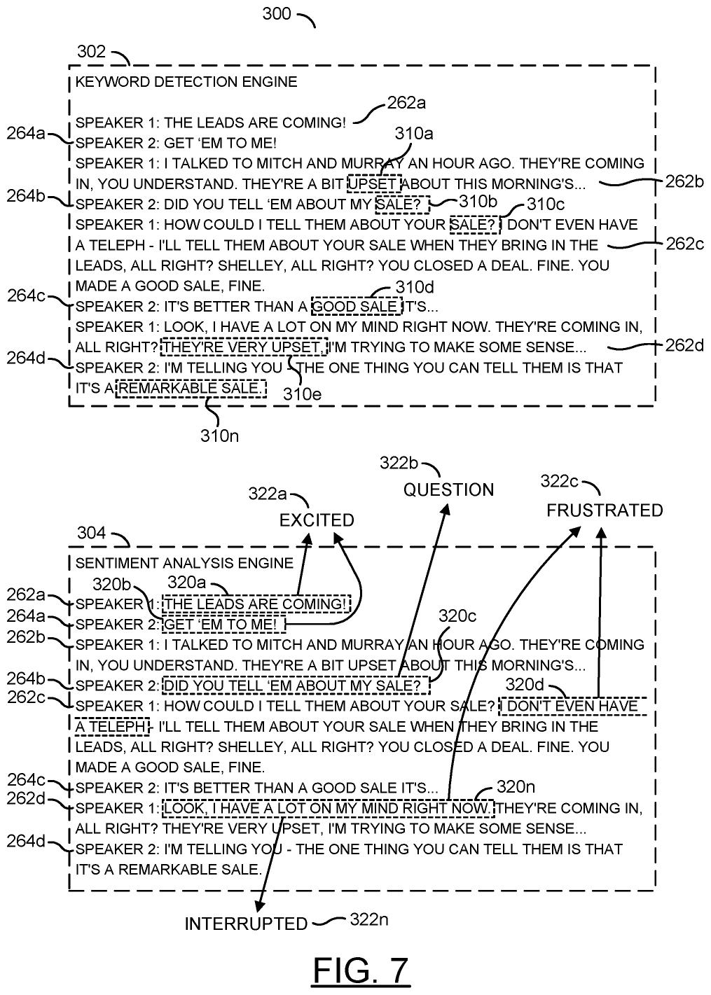

Referring to FIG. 7, a diagram illustrating operations performed by the audio processing engine 140 is shown. Example operations 300 are shown. In the example shown, the example operations 300 may comprise modules of the audio processing engine 140. The modules of the audio processing engine 140 may comprise a block (or circuit) 302 and/or a block (or circuit) 304. The block 302 may implement a keyword detection engine. The block 304 may implement a sentiment analysis engine. The blocks 302-304 may each comprise computer readable instructions that may be executed by the processor 130. The example operations 300 are not shown in any particular order (e.g., the example operations 300 may not necessarily rely on information from another module or sub-engine of the audio processing engine 140). The example operations 300 may be configured to provide various types of data that may be used to generate the reports 144.

The keyword detection engine 302 may comprise the text 260 categorized into the identified text 262a-262d and the identified text 264a-264d. In an example, the keyword detection operation may be performed after the speech-to-text operation and the diarization operation. The keyword detection engine 302 may be configured to find and match keywords 310a-310n in the audio stream ASTREAM. In one example, the keyword detection engine 302 may perform natural language processing (e.g., search the text 260 to find and match particular words). In another example, the keyword detection engine 302 may perform sound analysis directly on the audio stream ASTREAM to match particular sequences of sounds to keywords. The method of keyword detection performed by the keyword detection engine 302 may be varied according to the design criteria of a particular implementation.

The keyword detection engine 302 may be configured to search for a pre-defined list of words. The pre-defined list of words may be a list of words provided by an employer, a business owner, a stakeholder, etc. Generally, the pre-defined list of words may be selected based on desired business outcomes. In some embodiments, the pre-defined list of words may be a script. The pre-defined list of words may comprise words that may have a positive impact on achieving the desired business outcomes and words that may have a negative impact on achieving the desired business outcomes. In the example, the detected keyword 310a may be the word ‘upset’. The word ‘upset’ may indicate a negative outcome (e.g., an unsatisfied customer). In the example shown, the detected keyword 310b may be the word ‘sale’. The word ‘sale’ may indicate a positive outcome (e.g., a customer made a purchase). Some of the keywords 310a-310n may comprise more than one word. Detecting more than one word may provide context (e.g., a modifier of the word ‘no’ detected with the word ‘thanks’ may indicate a customer declining an offer, while the word ‘thanks’ alone may indicate a happy customer).

In some embodiments, the number of the detected keywords 310a-310n (or key phrases) spoken by the employees 50a-50n may be logged in the reports 144. In some embodiments, the frequency of the detected keywords 310a-310n (or key phrases) spoken by the employees 50a-50n may be logged in the reports 144. A measure of the occurrence of the keywords and/or keyphrases 310a-310n may be part of the metrics generated by the audio processing engine 140.

The sentiment analysis engine 304 may comprise the text 260 categorized into the identified text 262a-262d and the identified text 264a-264d. The sentiment analysis engine 304 may be configured to detect phrases 320a-320n to determine personality and/or emotions 322a-322n conveyed in the audio stream ASTREAM. In one example, the sentiment analysis engine 304 may perform natural language processing (e.g., search the text 260 to find and match particular phrases). In another example, the sentiment analysis engine 304 may perform sound analysis directly on the audio stream ASTREAM to detect changes in tone and/or expressiveness. The method of sentiment analysis performed by the sentiment analysis engine 304 may be varied according to the design criteria of a particular implementation.

Groups of words 320a-320n are shown. The groups of words 320a-320n may be detected by the sentiment analysis engine 304 by matching groups of keywords that form a phrase with a pre-defined list of phrases. The groups of words 320a-320n may be further detected by the sentiment analysis engine 304 by directly analyzing the sound of the audio signal ASTREAM to determine how the groups of words 320a-320n were spoken (e.g., loudly, quickly, quietly, slowly, changes in volume, changes in pitch, stuttering, etc.). In the example shown, the phrase 320a may comprise the words ‘the leads are coming!’ (e.g., the exclamation point may indicate an excited speaker, or an angry speaker). In another example, the phrase 320n may have been an interruption of the identified text 264c (e.g., an interruption may be impolite or be an indication of frustration or anxiousness). The method of identifying the phrases 320a-320n may be determined according to the design criteria of a particular implementation and/or the desired business outcomes.

Sentiments 322a-322n are shown. The sentiments 322a-322n may comprise emotions and/or type of speech. In the example shown, the sentiment 322a may be excitement, the sentiment 322b may be a question, the sentiment 322c may be frustration and the sentiment 322n may be an interruption. The sentiment analysis engine 304 may be configured to categorize the detected phrases 320a-320n according to the sentiments 322a-322n. The phrases 320a-320n may be categorized into more than one of the sentiments 322a-322n. For example, the phrase 320n may be an interruption (e.g., the sentiment 322n) and frustration (e.g., 322c). Other sentiments 322a-322n may be detected (e.g., nervousness, confidence, positivity, negativity, humor, sarcasm, etc.).

The sentiments 322a-322n may be indicators of the desired business outcomes. In an example, an employee that is excited may be seen by the customers 182a-182n as enthusiastic, which may lead to more sales. Having more of the spoken words of the employees 50a-50n with the excited sentiment 322a may be indicated as a positive trait in the reports 144. In another example, an employee that is frustrated may be seen by the customers 182a-182n as rude or untrustworthy, which may lead to customer dissatisfaction. Having more of the spoken words of the employees 50a-50n with the frustrated sentiment 322c may be indicated as a negative trait in the reports 144. The types of sentiments 322a-322n detected and how the sentiments 322a-322n are reported may be varied according to the design criteria of a particular implementation.

In some embodiments, the audio processing module 140 may comprise an artificial intelligence model trained to determine sentiment based on wording alone (e.g., the text 260). In an example for detecting positivity, the artificial intelligence model may be trained using large amounts of training data from various sources that have a ground truth as a basis (e.g., online reviews with text and a 1-5 rating already matched together). The rating system of the training data may be analogous to the metrics 142 and the text of the reviews may be analogous to the text 260 to provide the basis for training the artificial intelligence model. The artificial intelligence model may be trained by analyzing the text of an online review and predicting what the score of the rating would be and using the actual score as feedback. For example, the sentiment analysis engine 304 may be configured to analyze the identified text 262a-262d and the identified text 264a-264d using natural language processing to determine the positivity score based on the artificial intelligence model trained to detect positivity.

The various modules and/or sub-engines of the audio processing engine 140 may be configured to perform the various types of analysis on the audio stream input ASTREAM and generate the reports 144. The analysis may be performed in real-time as the audio is captured by the microphone 102a-102n, and transmitted to the server 108.

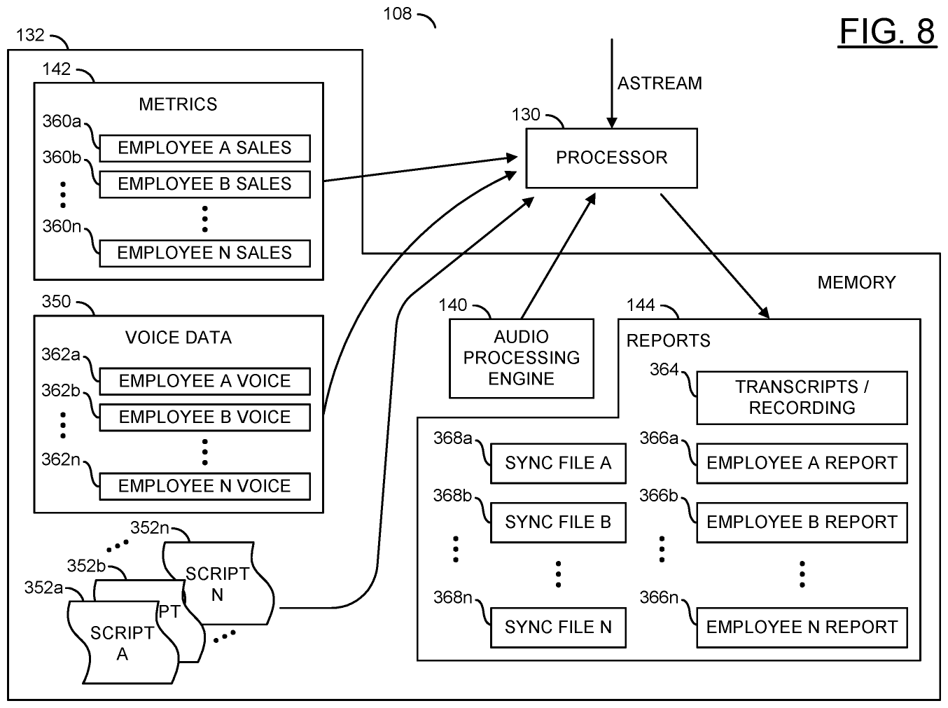

Referring to FIG. 8, a block diagram illustrating generating reports is shown. The server 108 comprising the processor 130 and the memory 132 are shown. The processor 130 may receive the input audio stream ASTREAM. The memory 132 may provide various input to the processor 130 to enable the processor to perform the analysis of the audio stream ASTREAM using the computer executable instructions of the audio processing engine 140. The processor 140 may provide output to the memory 132 based on the analysis of the input audio stream ASTREAM.

The memory 132 may comprise the audio processing engine 140, the metrics 142, the reports 144, a block (or circuit) 350 and/or blocks (or circuits) 352a-352n. The block 350 may comprise storage locations for voice data. The blocks 352a-352n may comprise storage location for scripts.

The metrics 142 may comprise blocks (or circuits) 360a-360n. The voice data 350 may comprise blocks (or circuits) 362a-362n. The reports 144 may comprise a block (or circuit) 364, blocks (or circuits) 366a-366n and/or blocks (or circuits) 368a-368n. The blocks 360a-360n may comprise storage locations for employee sales. The blocks 362a-362n may comprise storage locations for employee voice data. The block 364 may comprise transcripts and/or recordings. The blocks 366a-366n may comprise individual employee reports. The blocks 366a-366n may comprise sync files and/or sync data. Each of the metrics 142, the reports 144 and/or the voice data 350 may store other types and/or additional data. The amount, type and/or arrangement of the storage of data may be varied according to the design criteria of a particular implementation.

The scripts 352a-352n may comprise pre-defined language provided by an employer. The scripts 352a-352n may comprise the list of pre-defined keywords that the employees 50a-50n are expected to use when interacting with the customers 182a-182n. In some embodiments, the scripts 352a-352n may comprise word-for-word dialog that an employer wants the employees 50a-50n to use (e.g., verbatim). In some embodiments, the scripts 352a-352n may comprise particular keywords and/or phrases that the employer wants the employees 50a-50n to say at some point while talking to the customers 182a-182n. The scripts 352a-352n may comprise text files that may be compared to the text 260 extracted from the audio stream ASTREAM. One or more of the scripts 352a-352n may be provided to the processor 130 to enable the audio processing engine 140 to compare the audio stream ASTREAM to the scripts 352a-352n.

The employee sales 360a-360n may be an example of the metrics 142 that may be compared to the audio analysis to generate the reports 144. The employee sales 360a-360n may be one measurement of employee performance (e.g., achieving the desired business outcomes). For example, higher employee sales 360a-360n may reflect better employee performance. Other types of metrics 142 may be used for each employee 50a-50n. Generally, when the audio processing engine 140 determines which of the employees 50a-50n that a voice in the audio stream ASTREAM belongs to, the words spoken by the employee 50a-50n may be analyzed with respect to one of the employee sales 360a-360n that corresponds to the identified employee. For example, the employee sales 360a-360n may provide some level of ‘ground truth’ for the analysis of the audio stream ASTREAM. When the employee is identified the associated one of the employee sales 360a-360n may be communicated to the processor 130 for the analysis.

The metrics 142 may be acquired using the point-of-sale system (e.g., the cash register 184). For example, the cash register 184 may be integrated into the system 100 to enable the employee sales 360a-360n to be tabulated automatically. The metrics 142 may be acquired using backend accounting software and/or a backend database. Storing the metrics 142 may enable the processor 130 to correlate what is heard in the recording to the final outcome (e.g., useful for employee performance, and also for determining which script variations lead to better performance).

The employee voices 362a-362n may comprise vocal information about each of the employees 50a-50n. The employee voices 362a-362n may be used by the processor 130 to determine which of the employees 50a-50n is speaking in the audio stream ASTREAM. Generally, when one of the employees 50a-50n is speaking to one of the customers 182a-182n, only one of the voices in the audio stream ASTREAM may correspond to the employee voices 362a-362n. The employee voices 362a-362n may be used by the voice recognition engine 256 to identify one of the speakers as a particular employee. When the audio stream ASTREAM is being analyzed by the processor 130, the employee voices 362a-362n may be retrieved by the processor 130 to enable comparison with the frequency, tone and/or pitch of the voices recorded.

The transcripts/recordings 364 may comprise storage of the text 260 and/or the identified text 262a-262n and the identified text 264a-264n (e.g., the text transcriptions 210a-210n). The transcripts/recordings 364 may further comprise a recording of the audio from the signal ASTREAM. Storing the transcripts 364 as part of the reports 144 may enable human analysts to review the transcripts 364 and/or review the conclusions reached by the audio processing engine 140. In some embodiments, before the reports 144 are made available, a human analysts may review the conclusions.

The employee reports 366a-366n may comprise the results of the analysis by the processor 130 using the audio processing engine 140. The employee reports 366a-366n may further comprise results based on human analysis of the transcripts 364 and/or a recording of the audio stream ASTREAM. The employee reports 366a-366n may comprise individualized reports for each of the employees 50a-50n. The employee reports 366a-366n may, for each employee 50a-50n, indicate how often keywords were used, general sentiment, a breakdown of each sentiment, how closely the scripts 352a-352n were followed, highlight performance indicators, provide recommendations on how to improve achieving the desired business outcomes, etc. The employee reports 366a-366n may be further aggregated to provide additional reports (e.g., performance of a particular retail location, performance of an entire region, leaderboards, etc.).

In some embodiments, human analysts may review the transcripts/recordings 364. Human analysts may be able to notice unusual circumstances in the transcripts/recordings 364. For example, if the audio processing engine 140 is not trained for an unusual circumstances, the unusual circumstance may not be recognized and/or handled properly, which may cause errors in the employee reports 366a-366n.

The sync files 368a-368n may be generated in response to the transcripts/recordings 364. The sync files 368a-368n may comprise text from the text transcripts 210a-210n and embedded timestamps. The embedded timestamps may correspond to the audio in the audio stream ASTREAM. For example, the audio processing engine 140 may generate one of the embedded timestamps that indicates a time when a person begins speaking, another one of the embedded timestamps when another person starts speaking, etc. The embedded timestamps may cross-reference the text of the transcripts 210a-210n to the audio in the audio stream ASTREAM. For example, the sync files 368a-368n may comprise links (e.g., hyperlinks) that may be selected by an end-user to initiate playback of the recording 364 at a time that corresponds to one of the embedded timestamps that has been selected.

The audio processing engine 140 may be configured to associate the text 260 generated with the embedded timestamps from the audio stream ASTREAM that correspond to the sections of the text 260. The links may enable a human analyst to quickly access a portion of the recording 364 when reviewing the text 260. For example, the human analyst may click on a section of the text 260 that comprises a link and information from the embedded timestamps, and the server 108 may playback the recording starting from a time when the dialog that corresponds to the text 260 that was clicked on was spoken. The links may enable human analysts to refer back to the source audio when reading the text of the transcripts to verify the validity of the conclusions reached by the audio processing engine 140 and/or to analyze the audio using other methods.

In one example, the sync files 368a-368n may comprise ‘rttm’ files. The rttm files 368a-268n may store text with the embedded timestamps. The embedded timestamps may be used to enable audio playback of the recordings 364 by seeking to the selected timestamp. For example, playback may be initiated starting from the selected embedded timestamp. In another example, playback may be initiated from a file (e.g., using RTSP) from the selected embedded timestamp.

In some embodiments, the audio processing engine 140 may be configured to highlight deviations of the dialog of the employees 50a-50n in the audio stream ASTREAM from the scripts 352a-352n and human analysts may review the highlighted deviations (e.g., to check for accuracy, to provide feedback to the artificial intelligence model, etc.). The reports 144 may be curated for various interested parties (e.g., employers, human resources, stakeholders, etc.). In an example, the employee reports 366a-366n may indicate tendencies of each of the employees 50a-50n at each location (e.g., to provide information for a regional manager that overlooks multiple retail locations in an area). In another example, the employee reports 366a-366n may indicate an effect of each tendency on sales (e.g., to provide information for a trainer of employees to teach which tendencies are useful for achieving the desired business outcomes).

The transcripts/recordings 364 may further comprise annotations generated by the audio processing engine 140. The annotations may be added to the text 260 to indicate how the artificial intelligence model generated the reports 144. In an example, when the word ‘sale’ is detected by the keyword detection engine 302, the audio processing engine 140 may add the annotation to the transcripts/recordings 364 that indicates the employee has achieved a positive business outcome. The person doing the manual review may check the annotation, read the transcript and/or listen to the recording to determine if there actually was a sale. The person performing the manual review may then provide feedback to the audio processing engine 140 to train the artificial intelligence model.

In one example, the curated reports 144 may provide information for training new employees. For example, a trainer may review the employee reports 366a-366n to find which employees have the best performance. The trainer may use the techniques that are also used by the employees with the best performance to teach new employees. The new employees may be sent into the field and use the techniques learned during employee training. New employees may monitor the employee reports 366a-366n to see bottom-line numbers in the point of sale (PoS) system 184. New employees may further review the reports 366a-366n to determine if they are properly performing the techniques learned. The employees 50a-50n may be able to learn which techniques some employees are using that result in high bottom line numbers that they can use.

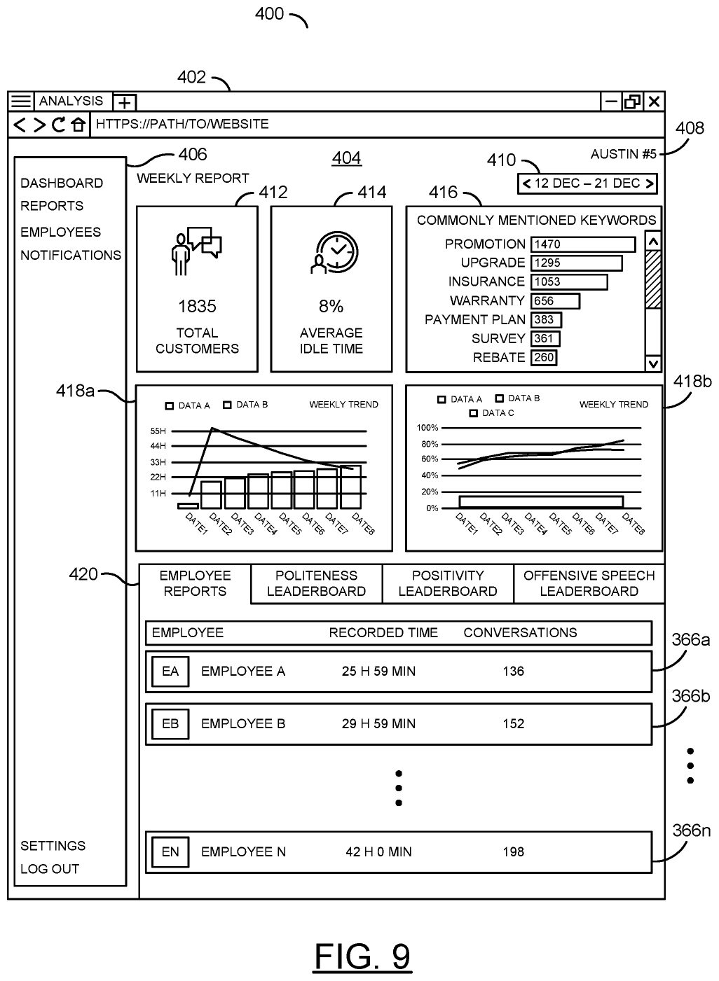

Referring to FIG. 9, a diagram illustrating a web-based interface for viewing reports is shown. A web-based interface 400 is shown. The web-based interface 400 may be an example representation of displaying the curated reports 144. The system 100 may be configured to capture all audio information from the interaction between the employees 50a-50n and the customers 182a-182n, perform the analysis of the audio to provide the reports 144. The reports 144 may be displayed using the web-based interface 400 to transform the reports 144 into useful insights.

The web-based interface 400 may be displayed in a web browser 402. The web browser 402 may display the reports 144 as a dashboard interface 404. In the example shown, the dashboard interface 404 may be a web page displayed in the web browser 402. In another example, the web-based interface 400 may be provided as a dedicated app (e.g., a smartphone and/or tablet app). The type of interface used to display the reports 144 may be varied according to the design criteria of a particular implementation.

The dashboard interface 404 may comprise various interface modules 406-420. The interface modules 406-420 may be re-organized and/or re-arranged by the end-user. The dashboard interface 404 is shown comprising a sidebar 406, a location 408, a date range 410, a customer count 412, an idle time notification 414, common keywords 416, data trend modules 418a-418b and/or report options 420. The interface modules 406-420 may display other types of data (not shown). The arrangement, types and/or amount of data shown by each of the interface modules 406-420 may be varied according to the design criteria of a particular implementation.

The sidebar 406 may provide a menu. The sidebar menu 406 may provide links to commonly used features (e.g., a link to return to the dashboard 404, detailed reports, a list of the employees 50a-50n, notifications, settings, logout, etc.). The location 408 may provide an indication of the current location that the reports 144 correspond to being viewed on the dashboard 404. In an example of a regional manager that overlooks multiple retail locations, the location 408 (e.g., Austin store #5) may indicate that the data displayed on the dashboard 404 corresponds to a particular store (or groups of stores). The date range 410 may be adjusted to display data according to particular time frames. In the example shown, the date range may be nine days in December. The web interface 400 may be configured to display data corresponding to data acquired hourly, daily, weekly, monthly, yearly, etc.

The customer count interface module 412 may be configured to display a total number of customers that the employees 50a-50n have interacted with throughout the date range 410. The idle time interface module 414 may provide an average of the amount of time that the employees 50a-50n were idle (e.g., not talking to the customers 182a-182n). The common keywords interface module 416 may display the keywords (e.g., from the scripts 352a-352n) that have been most commonly used by the employees 50a-50n when interacting with the customers 182a-182n as detected by the keyword detection engine 302.

The interface modules 412-416 may be examples of curated data from the reports 144. The end user viewing the web interface 400 may select settings to provide the server 108 with preferences on the type of data to show. In an example, in a call center, the average idle time 414 may be a key performance indicator. However, in a retail location the average idle time 414 may not be indicative of employee performance (e.g., when no customers in the store, the employee may still be productive by stocking shelves). However, in a retail store setting, the commonly mentioned keywords 416 may be more important performance indicators (e.g., upselling warranties may be the desired business outcome). The reports 144 generated by the server 108 in response to the audio analysis of the audio stream ASTREAM may be curated to the preferences of the end user to ensure that data relevant to the type of business is displayed.

The data trend modules 418a-418b may provide a graphical overview of the performance of the employees 50a-50n over the time frame of the date range 410. In an example, the data trend modules 418a-418n may provide an indicator of how the employees 50a-50n have responded to instructions from a boss (e.g., the boss informs employees to sell more warranties, and then the boss may check the trends 418a-418b to see if the keyword ‘warranties’ has been used by the employees 50a-50n more often). In another example, the data trend modules 418a-418n may provide data for employee training. A trainer may monitor how a new employee has improved over time.

The report options 420 may provide various display options for the output of the employee reports 366a-366n. In the example shown, a tab for employee reports is shown selected in the report options 420 and a list of the employee reports 366a-366n are shown below with basic information (e.g., name, amount of time covered by the transcripts/recordings 364, the number of conversations, etc.). In an example, the list of employee reports 366a-366n in the web interface 400 may comprise links that may open a different web page with more detailed reports for the selected one of the employees 50a-50n.

The report options 420 may provide alternate options for displaying the employee reports 366a-366n. In the example shown, selecting the politeness leaderboard may re-arrange the list of the employee records 366a-366n according to a ranking of politeness determined by the sentiment analysis engine 304. In the example shown, selecting the positivity leaderboard may re-arrange the list of the employee records 366a-366n according to a ranking of politeness determined by the sentiment analysis engine 304. In the example shown, selecting the offensive speech leaderboard may re-arrange the list of the employee records 366a-366n according to a ranking of which employees used the most/least offensive language determined by the sentiment analysis engine 304. Other types of ranked listings may be selected (e.g., most keywords used, which employees 50a-50n strayed from the scripts 352a-352n the most/least, which of the employees 50a-50n had the most sales, etc.).

The information displayed on the web interface 400 and/or the dashboard 404 may be generated by the server 108 in response to the reports 144. After the servers 108a-108n analyze the audio input ASTREAM, the data/conclusions/results may be stored in the memory 132 as the reports 144. End users may use the user computing devices 110a-110n to request the reports 144. The servers 108a-108n may retrieve the reports 144 and generate the data in the reports 144 in a format that may be read by the user computing devices 110a-110n as the web interface 400. The web interface 400 (or the app interface) may display the reports 144 in various formats that easily convey the data at a glance (e.g., lists, charts, graphs, etc.). The web interface 400 may provide information about long-term trends, unusual/aberrant data, leaderboards (or other gamification methods) that make the data easier to present to the employees 50a-50n as feedback (e.g., as a motivational tool), provide real-time notifications, etc. In some embodiments, the reports 144 may be provided to the user computing devices 110a-110n as a text message (e.g., SMS), an email, a direct message, etc.

The system 100 may comprise sound acquisition devices 102a-102n, data transmission devices 104a-104n and/or the servers 108a-108n. The sound acquisition devices 102a-102n may capture audio of the employees 50a-50n interacting with the customers 182a-182n and the audio may be transmitted to the servers 108a-108n using the data transmission devices 104a-104n. The servers 108a-108n may implement the audio processing engine 140 that may generate the text transcripts 210a-210n. The audio processing engine 140 may further perform various types of analysis on the text transcripts 210a-210n and/or the audio stream ASTREAM (e.g., keyword analysis, sentiment analysis, diarization, voice recognition, etc.). The analysis may be performed to generate the reports 144. In some embodiments, further review may be performed by human analysts (e.g., the text transcriptions 210a-210n may be human readable).

In some embodiments, the sound acquisition devices 102a-102n may be lapel (lavalier) microphones and/or wearable headsets. In an example, when the microphones 102a-102n are worn by a particular one of the employees 50a-50n, a device ID of the microphones 102a-102n (or the transmitters 104a-104n) may be used to identify one of the recorded voices as the voice of the employee that owns (or uses) the microphone with the detected device ID (e.g., the speaker that is most likely to be wearing the sound acquisition device on his/her body may be identified). In some embodiments, the audio processing engine 140 may perform diarization to separate each speaker in the recording by voice and the diarized text transcripts may be further cross-referenced against a voice database (e.g., the employee voices 362a-362n) so that the reports 144 may recognize and name the employees 50a-50n in the transcript 364.

In some embodiments, the reports 144 may be generated by the servers 108a-108n. In some embodiments, the reports 144 may be partially generated by the servers 108a-108n and refined by human analysis. For example, a person (e.g., an analyst) may review the results generated by the AI model implemented by the audio processing engine 140 (e.g., before the results are accessible by the end users using the user computing devices 110a-110n). The manual review by the analyst may further be used as feedback to train the artificial intelligence model.

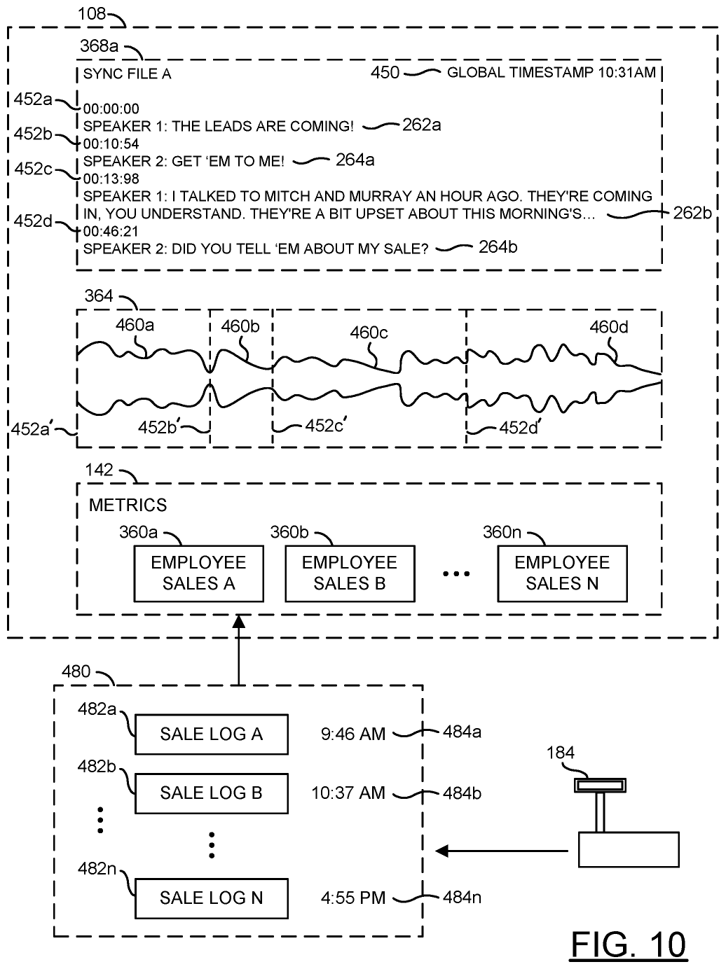

Referring to FIG. 10, a diagram illustrating an example representation of a sync file and a sales log is shown. The server 108 is shown comprising the metrics 142, the transcription/recording 364 and/or the sync file 368a. In the example shown, the sync data 368a is shown as an example file that may be representative of the sync files 368a-368n shown in association with FIG. 8 (e.g., a rttm file). Generally, the sync data 368a-368n may map words to timestamps. In one example, the sync data 368a-368n may be implemented as rttm files. In another example, the sync data 368a-368n may be stored as word and/or timestamp entries in a database. In yet another example, the sync data 368a-368n may be stored as annotations, metadata and/or a track in another file (e.g., the transcription/recording 364). The format of the sync data 368a-368n may be varied according to the design criteria of a particular implementation.

The sync data 368a may comprise the identified text 262a-262b and the identified text 264a-264b. In one example, the sync data 368a may be generated from the output of the diarization engine 254. In the example shown, the text transcription may be segmented into the identified text 262a-262n and the identified text 264a-264b. However, the sync data 368a may be generated from the text transcription 260 without additional operations performed (e.g., the output from the speech-to-text engine 252).

The sync data 368a may comprise a global timestamp 450 and/or text timestamps 452a-452d. In the example shown, the sync data 368a may comprise one text timestamp 452a-452d corresponding to one of the identified text 262a-262b or the identified text 264a-264b. Generally, the sync data 368a-368n may comprise any number of the text timestamps 452a-452n. The global timestamp 450 and/or the text timestamps 452a-452n may be embedded in the sync data 368a-368n.

The global timestamp 450 may be a time that the particular audio stream ASTREAM was recorded. In an example, The microphones 102a-102n and/or the transmitters 104a-104n may record a time that the recording was captured along with the captured audio data. The global timestamp 450 may be configured to provide a frame of reference for when the identified text 262a-262b and/or the identified text 264a-264b was spoken. In the example shown, the global timestamp 450 may be in a human readable format (e.g., 10:31 AM). In some embodiments, global timestamp may comprise a year, a month, a day of week, seconds, etc. In an example, the global timestamp 450 may be stored in a UTC format. The implementation of the global timestamp 450 may be varied according to the design criteria of a particular implementation.

The text timestamps 452a-452n may provide an indication of when the identified text 262a-262n and/or the identified text 264a-264n was spoken. In the example shown, the text timestamps 452a-452n are shown as relative timestamps (e.g., relative to the global timestamp 450). For example, the text timestamp 452a may be a time of 00:00:00, which may indicate that the associated identified text 262a may have been spoken at the time of the global timestamp 450 (e.g., 10:31 AM) and the text timestamp 452b may be a time of 00:10:54, which may indicate that the associated identified text 264a may have been spoken at a time 10.54 seconds after the time of the global timestamp 450. In some embodiments, the text timestamps 452a-452n may be an absolute time (e.g., the text timestamp 452a may be 10:31 AM, the text timestamp 452b may be 10:31:10:52 AM, etc.). The text timestamps 452a-452n may be configured to provide a quick reference to enable associating the text with the audio.

In some embodiments, the text timestamps 452a-452n may be applied at fixed (e.g., periodic) intervals (e.g., every 5 seconds). In some embodiments, the text timestamps 452a-452n may be applied during pauses in speech (e.g., portions of the audio stream ASTREAM that has low volume). In some embodiments, the text timestamps 452a-452n may be applied at the end of sentences and/or when a different person starts speaking (e.g., as determined by the diarization engine 254). In some embodiments, the text timestamps 452a-452n may be applied based on the metrics determined by the audio processing engine 140 (e.g., keywords have been detected, a change in sentiment has been detected, a change in emotion has been detected, etc.). When and/or how often the text timestamps 452a-452n are generated may be varied according to the design criteria of a particular implementation.

The audio recording 364 is shown as an audio waveform. The audio waveform 364 is shown with dotted vertical lines 452a′-452d′ and audio segments 460a-460d. The audio segments 460a-460d may correspond to the identified text 262a-262b and 264a-264d. For example, the audio segment 460a may be the portion of the audio recording 364 with the identified text 262a, the audio segment 460b may be the portion of the audio recording 364 with the identified text 264a, the audio segment 460c may be the portion of the audio recording 364 with the identified text 262b, and the audio segment 460d may be the portion of the audio recording 364 with the identified text 264b.

The dotted vertical lines 452a′-452d′ are shown at varying intervals along the audio waveform 364. The vertical lines 452a′-452d′ may correspond to the text timestamps 452a-452d. In an example, the identified text 262a may be the audio portion 460a that starts from the text timestamp 452a′ and ends at the text timestamp 452b′. The sync data 368a may use the text timestamps 452a′-452d′ to enable playback of the audio recording 364 from a specific time. For example, if an end user wanted to hear the identified text 262b, the sync data 368a may provide the text timestamp 452c and the audio recording 364 may be played back starting with the audio portion 460c at the time 13.98 from the global timestamp 450.

In one example, the web-based interface 400 may provide a text display of the identified text 262a-262b and the identified text 264a-264b. The identified text 262a-262b and/or the identified text 264a-264b may be highlighted as clickable links. The clickable links may be associated with the sync data 368a (e.g., each clickable link may provide the text timestamps 452a-452d associated with the particular identified text 262a-262b and/or 264a-264b). The clickable links may be configured to activate audio playback of the audio waveform 364 starting from the selected one of the text timestamps 452a-452d by the end user clicking the links. The implementation of the presentation of the sync data 368a-368n to the end user may be varied according to the design criteria of a particular implementation.

The cash register 184 is shown. The cash register 184 may be representative of a point-of-sales (POS) system configured to receive orders. In an example, one or more of the employees 50a-50n may operate the cash register 184 to input sales information and/or perform other sales-related services (e.g., accept money, print receipts, access sales logs, etc.). A dotted box 480 is shown. The dotted box 480 may represent a transaction log. The cash register 184 may be configured to communicate with and/or access the transaction log 480. In one example, the transaction log 480 may be implemented by various components of the cash register 184 (e.g., a processor writing to and/or reading from a memory implemented by the cash register 184). In another example, the transaction log 480 may be accessed remotely by the cash register 184 (e.g., the gateway device 106 may provide the transaction log 480, the servers 108a-108n may provide the transaction log 480 and/or other server computers may provide the transaction log 480). In the example shown, one cash register 184 may access the transaction log 480. However, the transaction log 480 may be accessed by multiple POS devices (e.g., multiple cash registers implemented in the same store, cash registers implemented in multiple stores, company-wide access, etc.). The implementation of the transaction log 480 may be varied according to the design criteria of a particular implementation.

The transaction log 480 may comprise sales data 482a-482n and sales timestamps 484a-484n. In one example, the sales data 482a-482n may be generated by the POS device 184 in response to input by the employees 50a-50n. In another example, the sales data 482a-482n may be managed by software (e.g., accounting software), etc.

The sales data 482a-482n may comprise information and/or a log about each sale made. In an example, the sales data 482a-482n may comprise an invoice number, a value of the sale (e.g., the price), the items sold, the employees 50a-50n that made the sale, the manager in charge when the sale was made, the location of the store that the sale was made in, item numbers (e.g., barcodes, product number, SKU number, etc.) of the products sold, the amount of cash received, the amount of change given, the type of payment, etc. In the example shown, the sales data 482a-482n may be described in the context of a retail store. However, the transaction log 480 and/or the sales data 482a-482n may be similarly implemented for service industries. In an example, the sales data 482a-482n for a customer service call-center may comprise data regarding how long the phone call lasted, how long the customer was on hold, a review provided by the customer, etc. The type of information stored by the sales data 482a-482n may generally provide data that may be used to measure various metrics of success of a business. The type of data stored in the sales logs 482a-482n may be varied according to the design criteria of a particular implementation.

Each of the sales timestamps 484a-484n may be associated with one of the sales data 482a-482n. The sales timestamps 484a-484n may indicate a time that the sale was made (or service was provided). The sales timestamps 484a-484n may have a similar implementation as the global timestamp 450. While the sales timestamps 484a-484n is shown separately from the sales data 482a-482n for illustrative purposes, the sales timestamps 484a-484n may be data stored with the sales data 482a-482n.

Data from the transaction log 480 may be provided to the server 108. The data from the transaction log 480 may be stored as the metrics 142. In the example shown, the data from the transaction log 480 may be stored as part of the employees sales data 360a-360n. In an example, the sales data 482a-482n from the transaction log 480 may be uploaded to the server 108, and the processor 130 may analyze the sales data 482a-482n to determine which of the employees 50a-50n are associated with the sales data 482a-482n. The sales data 482a-482n may then be stored as part of the employee sales 360a-360n according to which of the employees 50a-50n made the sale. In an example, if the employee 50a made the sale associated with the sales data 482b, the data from the sales data 482b may be stored as part of the metrics 142 as the employee sales 360a.

The processor 130 may be configured to determine which of the employees 50a-50n are in the transcripts 210a-210n based on the sales timestamps 484a-484n, the global timestamps 450 and/or the text timestamps 452a-452n. In the example shown, the global timestamp 450 of the sync data 368a may be 10:31 AM and the sales timestamp 484b of the sales data 482b may be 10:37 AM. The identified text 262a-262b and/or the identified text 264a-264b may represent a conversation between one of the employees 50a-50n and one of the customers 182a-182n that started at 10:31 AM (e.g., the global timestamp 450) and resulted in a sale being entered at 10:37 AM (e.g., the sales timestamps 484b). The processor 130 may determine that the sales data 482b has been stored with the employee sales 360a, and as a result, one of the speakers in the sync data 368a may be the employee 50a. The text timestamps 452a-452n may then be used to determine when the employee 50a was speaking. The audio processing engine 140 may then analyze what the employee 50a said (e.g., how the employee 50a spoke, which keywords were used, the sentiment of the words, etc.) that led to the successful sale recorded in the sales log 482b.

The servers 108a-108n may receive the sales data 482a-482n from the transaction log 480. For example, the cash register 184 may upload the transaction log 480 to the servers 108a-108n. The audio processing engine 140 may be configured to compare the sales data 482a-482n to the audio stream ASTREAM. The audio processing engine 140 may be configured to generate the curated employee reports 366a-366n that summarize the correlations between the sales data 482a-482n (e.g., successful sales, customers helped, etc.) and the timing of events that occurred in the audio stream ASTREAM (e.g., based on the global timestamp 450 and the text timestamps 452a-452n). The events in the audio stream ASTREAM may be detected in response to the analysis of the audio stream ASTREAM performed by the audio processing module 140. In an example, audio of the employee 50a asking the customer 182a if they need help and recommending the merchandise 186a may be correlated to the successful sale of the merchandise 186a based on the sales timestamp 484b being close to (or matching) the global timestamp 450 and/or one of the text timestamps 452a-452n of the recommendation by the employee 50a.

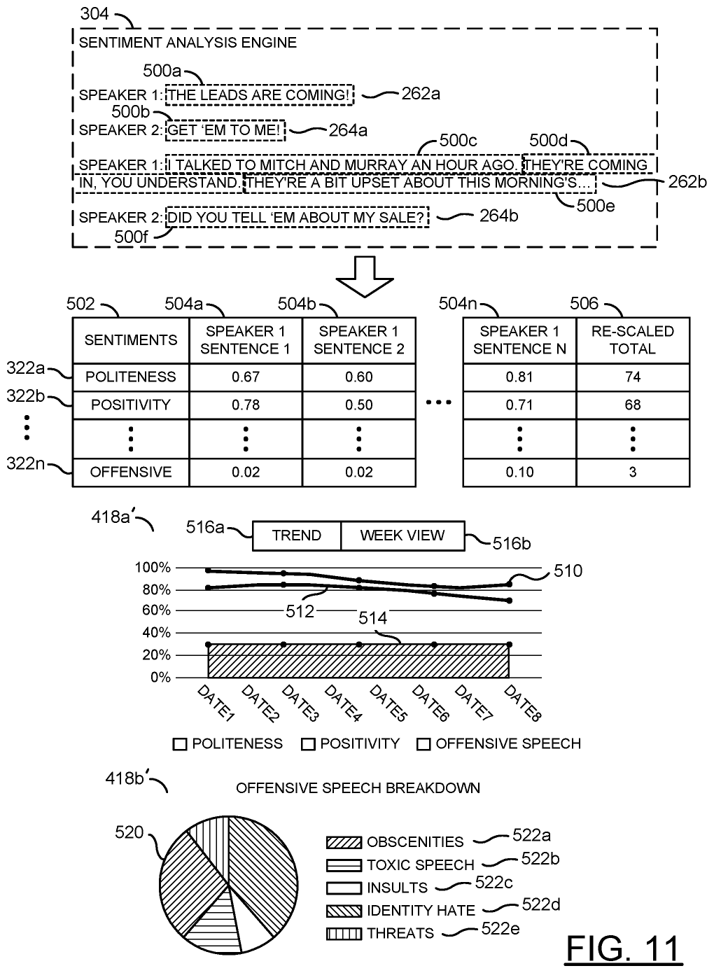

Referring to FIG. 11, a diagram illustrating example reports generated in response sentiment analysis performed by an audio processing engine is shown. An alternate embodiment of the sentiment analysis engine 304 is shown. The sentiment analysis engine 304 may comprise the text 260 categorized into the identified text 262a-262b and the identified text 264a-264b. The sentiment analysis engine 304 may be configured determine a sentiment, a speaking style, a disposition towards another person and/or an emotional state of the various speakers conveyed in the audio stream ASTREAM. In an example, the sentiment analysis engine 304 may measure a positivity of a person talking, which may not be directed towards another person (e.g., a customer) but may be a measure of a general disposition and/or speaking style. The method of sentiment analysis performed by the sentiment analysis engine 304 may be varied according to the design criteria of a particular implementation.

The sentiment analysis engine 304 may be configured to detect sentences 500a-500n in the text 260. In the example shown, the sentence 500a may be the identified text 262a, the sentence 500b may be the identified text 264a, the sentences 500c-500e may each be a portion of the identified text 262b and the sentence 500f may be the identified text 264b. The sentiment analysis engine 304 may determine how the identified text 262a-262b and/or the identified text 264a-264b is broken down into the sentences 500a-500f based on the output text 260 of the speech-to-text engine 252 (e.g., the speech-to-text engine 252 may convert the audio into sentences based on pauses in the audio and/or natural text processing). In the example shown, the sentiment analysis engine 304 may be performed after the identified text 262a-252b and/or 264a-264b has been generated by the diarization engine 254. However, in some embodiments, the sentiment analysis engine 304 may operate on the text 260 generated by the speech-to-text engine 252.

A table comprising a column 502, columns 504a-504n and/or a column 506 is shown. The table may comprise rows corresponding to the various sentiments 322a-322n. The table may provide an illustration of the analysis performed by the sentiment analysis engine 304. The sentiment analysis engine 304 may be configured to rank each of the sentences 500a-500n based on the parameters (e.g., for the different sentiments 322a-322n). The sentiment analysis engine 304 may average the scores for each of the sentences 500a-500n for each of the sentiments 322a-322n over the entire text section. The sentiment analysis engine 304 may then add up the scores for all the sentences 500a-500n and perform a normalization operation to re-scale the scores.

The column 502 may provide a list of the sentiments 322a-322n (e.g., politeness, positivity, offensive speech, etc.). Each of the columns 504a-504n may show the scores of each of the sentiments 322a-322n for one of the sentences 500a-500n for a particular person. In the example shown, the column 504a may correspond to the sentence 500a of Speaker 1, the column 504b may correspond to the sentence 500c of Speaker 1, the column 504n may correspond to the sentence 500e of Speaker 1. The column 506 may provide the re-scaled total score for each of the sentiments 322a-322n determined by the sentiment analysis engine 304.

In one example, the sentence 500a (e.g., the identified text 262a) may be ranked having a politeness score of 0.67, a positivity score of 0.78, and an offensive speech score of 0.02 (e.g., 0 obscenities and 0 offensive words, 0 toxic speech, 0 identity hate, 0 threats, etc.). Each of the sentences 500a-500n spoken by the employees 50a-50n and/or the customers 182a-182n may similarly be scored for each of the sentiments 322a-322n. In the example shown, the re-scaled total for Speaker 1 for the politeness sentiment 322 throughout the sentences 500a-500n may be 74, the re-scaled total for Speaker 1 for the positivity sentiment 322b throughout the sentences 500a-500n may be 68, and the re-scaled total for Speaker 1 for the offensiveness sentiment 322n throughout the sentences 500a-500n may be 3. The re-scaled scores of the column 506 may be the output of the sentiment analysis engine 304 that may be used to generate the reports 144 (e.g., the employee reports 366a-366n).

Example data trend modules 418a′-418b′ generated from the output of the sentiment analysis module 304 are shown. The data trend modules 418a′-418b′ may be examples of the curated reports 144. In an example, the data trend modules 418a′-418b′ may be displayed on the dashboard 404 of the web interface 400 shown in association with FIG. 9. In one example, the trend data in the modules 418a′-418b′ may be an example for a single one of the employees 50a-50n. In an other example, the trend data in the modules 418a′-418b′ may be an example for a group of employees.

In the example shown, the data trend module 418a′ may display a visualization of trend data of the various sentiments 322a-322n. A trend line 510, a trend line 512 and a trend line 514 are shown. The trend line 510 may indicate the politeness sentiment 322a over time. The trend line 512 may indicate the positivity sentiment 322b over time. The trend line 514 may indicate the offensive speech sentiment 322n over time.

Buttons 516a-516b are shown. The buttons 516a-516b may enable the end user to select alternate views of the trend data. In one example, the button 516a may provide a trend view over a particular date range (e.g., over a full year). In another example, the button 516b may provide the trend data for the current week.

In the example shown, the data trend module 418b′ may display a pie chart visualization of the trend data for one particular sentiment. The pie chart 520 may provide a chart for various types of the offensive speech sentiment 322n. The sentiment types (or sub-categories) 522a-522e are shown as a legend for the pie chart 520. The pie chart 520 may provide a breakdown for offensive speech that has been identified as use of the obscenities 522a, toxic speech 522b, insults 522c, identity hate 522d and/or threats 522e. The sentiment analysis engine 304 may be configured detect each of the types 522a-522e of offensive speech and provide results as an aggregate (e.g., the offensive speech sentiment 322n) and/or as a breakdown of each type of offensive speech 522a-522n. In the example shown, the breakdown of the types 522a-522n may be for the offensive speech sentiment 322n. However, the sentiment analysis engine 304 may be configured to detect various types of any of the sentiments 322a-322n (e.g., detecting compliments as a type of politeness, detecting helpfulness as a type of politeness, detecting encouragement as a type of positivity, etc.). The types 522a-522n of a particular one of the sentiments 322a-322n detected may be varied according to the design criteria of a particular implementation.

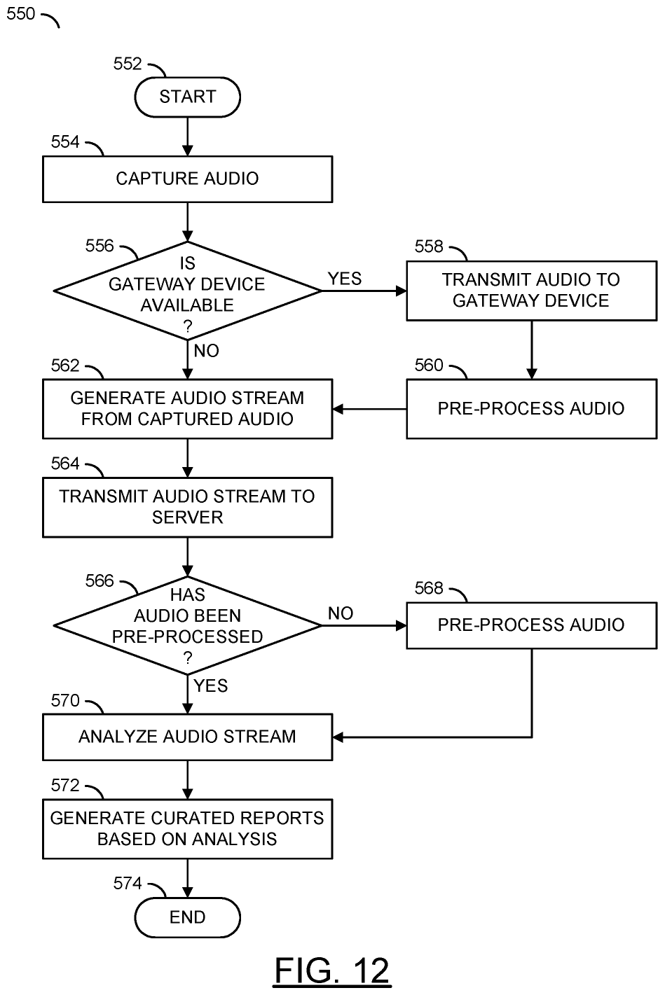

Referring to FIG. 12, a method (or process) 550 is shown. The method 550 may generate reports in response to audio analysis. The method 550 generally comprises a step (or state) 552, a step (or state) 554, a decision step (or state) 556, a step (or state) 558, a step (or state) 560, a step (or state) 562, a step (or state) 564, a decision step (or state) 566, a step (or state) 568, a step (or state) 570, a step (or state) 572, and a step (or state) 574.

The step 552 may start the method 550. In the step 554, the microphones (or arrays of microphones) 102a-102n may capture audio (e.g., the audio input signals SP_A-SP_N). The captured audio signal AUD may be provided to the transmitters 104a-104n. Next, the method 550 may move to the decision step 556.

In the decision step 556, the transmitters 104a-104n may determine whether the gateway device 106 is available. If the gateway device 106 is available, the method 550 may move to the step 558. In the step 558, the transmitters 104a-104n may transmit the audio signal AUD′ to the gateway device 106. In the step 560, the processor 122 of the gateway device 106 may perform pre-processing on the audio. Next, the method 550 may move to the step 562. In the decision step 556, if the gateway device 106 is not available, then the method 550 may move to the step 562.

In the step 562, the transmitters 104a-104n and/or the gateway device 106 may generate the audio stream ASTREAM from the captured audio AUD. Next, in the step 564, the transmitters 104a-104n and/or the gateway device 106 may transmit the audio stream ASTREAM to the servers 108a-108n. In one example, if the gateway device 106 is implemented, then the signal ASTREAM may comprise the pre-processed audio. In another example, if there is no gateway device 106, the transmitters 104a-104n may communicate with the servers 108a-108n (or communicate to the router 54 to enable communication with the servers 108a-108n) to transmit the signal ASTREAM. Next, the method 550 may move to the decision step 566.

In the decision step 566, the processor 130 of the servers 108a-108n may determine whether the audio stream ASTREAM has already been pre-processed. For example, the audio stream ASTREAM may be pre-processed when transmitted by the gateway device 106. If the audio stream ASTREAM has not been pre-processed, then the method 550 may move to the step 568. In the step 568, the processor 130 of the servers 108a-108n may perform the pre-processing of the audio stream ASTREAM. Next, the method 550 may move to the step 570. In the decision step 566, if the audio has not been pre-processed, then the method 550 may move to the step 570.

In the step 570, the audio processing engine 140 may analyze the audio stream ASTREAM. The audio processing engine 140 may operate on the audio stream ASTREAM using the various modules (e.g., the text-to-speech engine 252, the diarization engine 254, the voice recognition engine 256, the keyword detection engine 302, the sentiment analysis engine 304, etc.) in any order. Next, in the step 572, the audio processing engine 140 may generate the curated reports 144 in response to the analysis performed on the audio stream ASTREAM. Next, the method 550 may move to the step 574. The step 574 may end the method 550.

The method 550 may represent a general overview of the end-to-end process implemented by the system 100. Generally, the system 100 may be configured to capture audio, transmit the captured audio to the servers 108a-108n, pre-process the captured audio (e.g., remove noise). The pre-processing of the audio may be performed before or after transmission to the servers 108a-108n. The system 100 may perform analysis on the audio stream (e.g., transcription, diarization, voice recognition, segmentation into conversations, etc.) to generate metrics. The order of the types of analysis performed may be varied. The system 100 may collect metrics based on the analysis (e.g., determine the start of conversations, duration of the average conversation, an idle time, etc.). The system 100 may scan for known keywords and/or key phrases, analyze sentiments, analyze conversation flow, compare the audio to known scripts and measure deviations, etc. The results of the analysis may be made available for an end-user to view. In an example, the results may be presented as a curated report to present the results in a visually-compelling way.

The system 100 may operate without any pre-processing on the gateway device 106 (e.g., the gateway device 106 may be optional). In some embodiments, the gateway device 106 may be embedded into the transmitter devices 104a-104n and/or the input devices 102a-102n. For example, the transmitter 104a and the gateway device 106 may be integrated into a single piece of hardware.

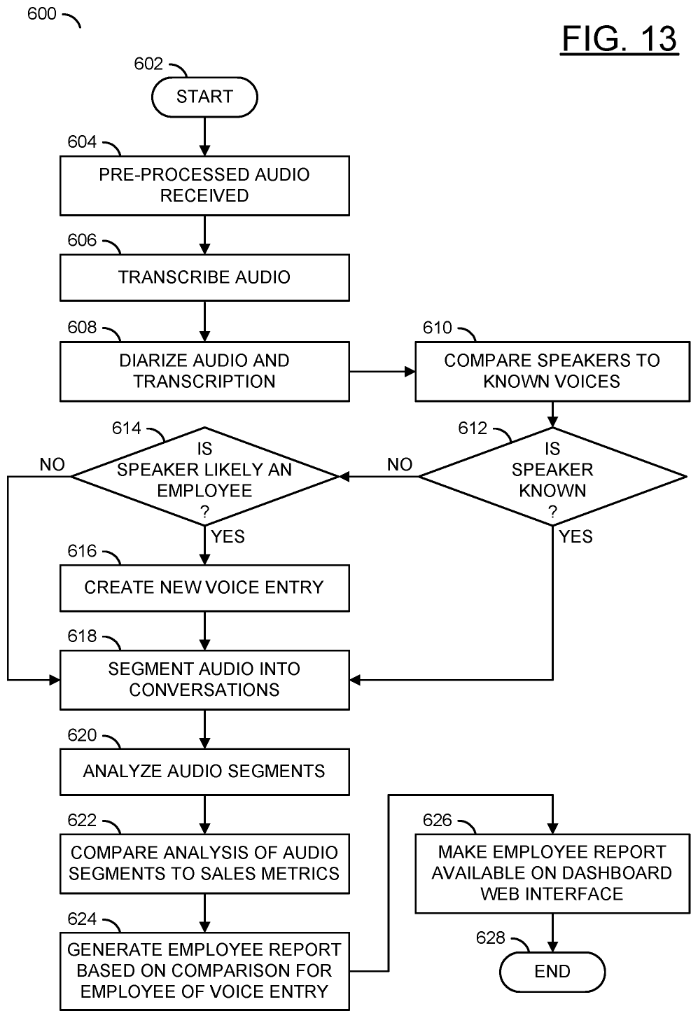

Referring to FIG. 13, a method (or process) 600 is shown. The method 600 may perform audio analysis. The method 600 generally comprises a step (or state) 602, a step (or state) 604, a step (or state) 606, a step (or state) 608, a step (or state) 610, a decision step (or state) 612, a decision step (or state) 614, a step (or state) 616, a step (or state) 618, a step (or state) 620, a step (or state) 622, a step (or state) 624, a step (or state) 626, and a step (or state) 628.

The step 602 may start the method 600. In the step 604, the pre-processed audio stream ASTREAM may be received by the servers 108a-108n. In the step 606, the speech-to-text engine 252 may be configured to transcribe the audio stream ASTREAM into the text transcriptions 210a-210n. Next, in the step 608, the diarization engine 254 may be configured to diarize the audio and/or text transcriptions 210a-210n. In an example, the diarization engine 254 may be configured to partition the audio and/or text transcriptions 210a-210n into homogeneous segments. In the step 610, the voice recognition engine 256 may compare the voice of the speakers in the audio stream ASTREAM to the known voices 362a-362n. For example, the voice recognition engine 256 may be configured to distinguish between a number of voices in the audio stream ASTREAM and compare each voice detected with thte stored known voices 362a-362n. Next, the method 600 may move to the decision step 612.

In the decision step 612, the speech-to-text engine 256 may determine whether the voice in the audio stream ASTREAM is known. For example, the speech-to-text engine 256 may compare the frequency of the voice in the audio stream ASTREAM to the voice frequencies stored in the voice data 350. If the speaker is known, then the method 600 may move to the step 618. If the speaker is not known, then the method 600 may move to the decision step 614.

In the decision step 614, the speech-to-text engine 256 may determine whether the speaker is likely to be an employee. For example, the audio processing engine 140 may determine whether the voice has a high likelihood of being one of the employees 50a-50n (e.g., based on the content of the speech, such as whether the person is attempting to make a sale rather than making a purchase). If the speaker in the audio stream ASTREAM is not likely to be one of the employees 50a-50n (e.g., the voice belongs to one of the customers 182a-182n), then the method 600 may move to the step 618. If the speaker in the audio stream ASTREAM is likely to be one of the employees 50a-50n, then the method 600 may move to the step 616. In the step 616, the speech-to-text engine 256 may create a new voice entry as one of the employee voices 362a-362n. Next, the method 600 may move to the step 618.

In the step 618, the diarization engine 254 may segment the audio stream ASTREAM into conversation segments. For example, the conversation segments may be created based on where conversations begin and end (e.g., detect the beginning of a conversation, detect an end of the conversation, detect a beginning of an idle time, detect an end of an idle time, then detect the beginning of a next conversation, etc.). In the step 620, the audio processing engine 140 may analyze the audio segments (e.g., determine keywords used, adherence to the scripts 352a-352n, determine sentiment, etc.). Next, in the step 622, the audio processing engine 140 may compare the analysis of the audio to the employee sales 360a-360n. In the step 624, the processor 130 may generate the employee reports 366a-366n. The employee reports 366a-366n may be generated for each of the employees 50a-50n based on the analysis of the audio stream ASTREAM according to the known voice entries 362a-362n. Next, in the step 626, the processor 130 may make the employee reports 366a-366n available on the dashboard interface 404 of the web interface 400. Next, the method 600 may move to the step 628. The step 628 may end the method 600.

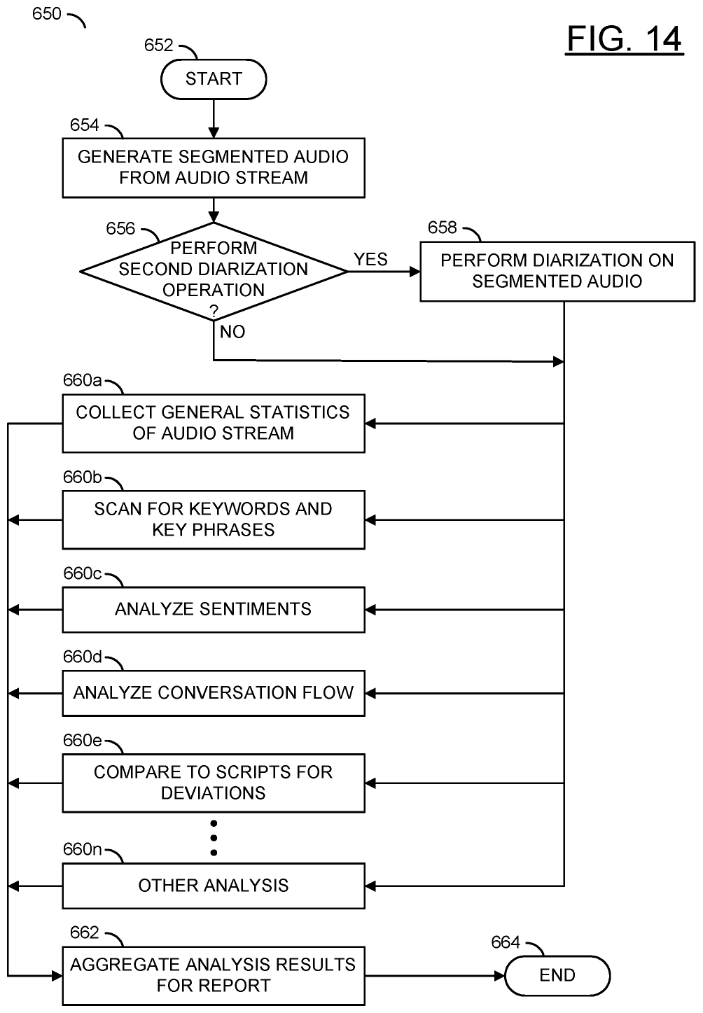

Referring to FIG. 14, a method (or process) 650 is shown. The method 650 may determine metrics in response to voice analysis. The method 650 generally comprises a step (or state) 652, a step (or state) 654, a decision step (or state) 656, a step (or state) 658, a step (or state) 660a, a step (or state) 660b, a step (or state) 660c, a step (or state) 660d, a step (or state) 660e, a step (or state) 660n, a step (or state) 662, and a step (or state) 664.

The step 652 may start the method 650. In the step 654, the audio processing engine 140 may generate the segmented audio from the audio stream ASTREAM. Segmenting the audio into conversations may enable the audio processing engine 140 to operate more efficiently (e.g., process smaller amounts of data at once). Segmenting the audio into conversations may provide more relevant results (e.g., results from one conversation segment that corresponds to a successful sale may be compared to one conversation segment that corresponds to an unsuccessful sale rather than providing one overall result). Next, the method 650 may move to the decision step 656.

In the decision step 656, the audio processing engine 140 may determine whether to perform a second diarization operation. Performing diarization after segmentation may provide additional insights about who is speaking and/or the role of the speaker in a conversation segment. For example, a first diarization operation may be performed on the incoming audio ASTREAM and a second diarization operation may be performed after segmenting the audio into conversations (e.g., performed on smaller chunks of audio). If a second diarization operation is to be performed, then the method 650 may move to the step 658. In the step 658, the diarization engine 254 may perform diarization on the segmented audio. Next, the method 650 may move to the steps 660a-660n. If the second diarization operation is not performed, then the method 650 may move to the steps 660a-660n.

The steps 660a-660n may comprise various operations and/or analysis performed by the audio processing engine 140 and/or the sub-modules/sub-engines of the audio processing engine 140. In some embodiments, the steps 660a-660n may be performed in parallel (or substantially in parallel). In some embodiments, the steps 660a-660n may be performed in sequence. In some embodiments, some of the steps 660a-660n may be performed in sequence and some of the steps 660a-660n may be performed in parallel. For example, some of the steps 660a-660n may rely on output from the operations performed in other of the steps 660a-660n. In one example, diarization and speaker recognition may be run before transcription or transcription may be performed before diarization and speaker recognition. The implementations and/or sequence of the operations and/or analysis performed in the steps 660a-660n may be varied according to the design criteria of a particular implementation.

In the step 660a, the audio processing engine 140 may collect general statistics of the audio stream (e.g., the global timestamp 450, the length of the audio stream, the bitrate, etc.). In the step 660b, the keyword detection engine 302 may scan for the keywords and/or key phrases 310a-310n. In the step 660c the sentiment analysis engine 304 may analyze the sentences 500a-500n for the sentiments 322a-322n. In the step 660d the audio processing engine 140 may analyze the conversation flow. In the step 660e, the audio processing engine 140 may compare the audio to the scripts 352a-352n for deviations. For example, the audio processing engine 140 may cross-reference the text from the scripts 352a-352n to the text transcript 210a-210n of the audio stream ASTREAM to determine if the employee has deviated from the scripts 352a-352n. The text timestamps 452a-452n may be used to determine when the employee has deviated from the scripts 352a-352n, how long the employee has deviated from the scripts 352a-352n, whether the employee returned to the content in the scripts 352a-352n and/or the effect of the deviations from the scripts 352a-352n had on the employee sales 360a-360n (e.g., improved sales, decreased sales, no impact, etc.). Other types of analysis may be performed by the audio processing engine 140 in the steps 660a-660n.

After the steps 660a-660n, the method 650 may move to the step 662. In the step 662, the processor 130 may aggregate the results of the analysis performed in the steps 660a-660n for the employee reports 366a-366n. Next, the method 650 may move to the step 664. The step 664 may end the method 650.

Embodiments of the system 100 have been described in the context of generating the reports 144 in response to analyzing the audio ASTREAM. The reports 144 may be generated by comparing the analysis of the audio stream ASTREAM to the business outcomes provided in the context of the sales data 360a-360n. In some embodiments, the system 100 may be configured to detect employee behavior based on video and/or audio. For example, the capture of audio using the audio input devices 102a-102n may be enhanced with additional data captured using video cameras. Computer vision operations may be performed to detect objects, classify objects as the employees 50a-50n, the customers 182a-182n and/or the merchandise 186a-186n.

Computer vision operations may be performed on captured video to determine the behavior of the employees 50a-50n. Similar to how the system 100 correlates the audio analysis to the business outcomes, the system 100 may be further configured to correlate employee behavior determined using video analysis to the business outcomes. In an example, the system 100 may perform analysis to determine whether the employees 50a-50n approaching the customers 182a-182n led to increased sales, whether the employees 50a-50n helping the customers 182a-182n select the merchandise 186a-186n improved sales, whether the employees 50a-50n walking with the customers 182a-182n to the cash register 184 improved sales, etc. Similarly, annotated video streams identifying various types of behavior may be provided in the curated reports 144 to train new employees and/or to instruct current employees. The types of behavior detected using computer vision operations may be varied according to the design criteria of a particular implementation.

The functions performed by the diagrams of FIGS. 1-14 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. A system comprising:
an audio input device configured to capture audio;
a transmitter device configured to (i) receive said audio from said audio input device and (ii) wirelessly communicate said audio; and
a server computer (A) configured to receive an audio stream based on said audio and (B) comprising a processor and a memory configured to execute computer readable instructions that (i) implement an audio processing engine and (ii) make a curated report available in response to said audio stream, wherein said audio processing engine is configured to (a) distinguish between a plurality of voices of said audio stream, (b) perform analytics on said audio stream to determine metrics corresponding to one or more of said plurality of voices and (c) generate said curated report based on said metrics.

2. The system according to claim 1, further comprising a gateway device configured to (i) receive said audio from said transmitter device, (ii) perform pre-processing on said audio, (iii) generate said audio stream in response to pre-processing said audio and (iv) transmit said audio stream to said server.

3. The system according to claim 2, wherein (a) said gateway device is implemented local to said audio input device and said transmitter device and (b) said gateway device communicates with said server computer over a wide area network.

4. The system according to claim 1, wherein (i) said audio comprises an interaction between an employee and a customer, (ii) a first of said plurality of voices comprises a voice of said employee and (iii) a second of said plurality of voices comprises a voice of said customer.

5. The system according to claim 1, wherein said audio input device comprise at least one of (a) a lapel microphone worn by an employee, (b) a headset microphone worn by said employee, (c) a mounted microphone, (d) a microphone or array of microphones mounted near a cash register, (e) a microphone or array of microphones mounted to a wall and (f) a microphone embedded into a wall-mounted camera.

6. The system according to claim 1, wherein (i) said transmitter device and said audio input device are at least one of (a) connected via a wire, (b) physically plugged into one another and (c) embedded into a single housing to implement at least one of (A) a single wireless microphone device and (B) a single wireless headset device and (ii) said transmitter device is configured to perform at least one of (a) radio-frequency communication, (b) Wi-Fi communication and (c) Bluetooth communication.

7. The system according to claim 1, wherein said transmitter device comprises a battery configured to provide a power supply for said transmitter device and said audio input device.

8. The system according to claim 1, wherein said audio processing engine is configured to convert said plurality of voices into a text transcript.

9. The system according to claim 8, wherein (i) said curated report comprises said text transcript, (ii) said text transcript is in a human-readable format and (iii) said text transcript is diarized to provide an identifier for text corresponding to each of said plurality of voices.

10. The system according to claim 8, wherein said analytics performed by said audio processing engine are implemented by (i) a speech-to-text engine configured to convert said audio stream to said text transcript and (ii) a diarization engine configured to partition said audio stream into homogeneous segments according to a speaker identity.

11. The system according to claim 8, wherein (i) said analytics comprise (a) comparing said text transcript to a pre-defined script and (b) identifying deviations of said text transcript from said pre-defined script and (ii) said curated report comprises (a) said deviations performed by each employee and (b) an effect of said deviations on sales.

12. The system according to claim 8, wherein (i) said audio processing engine is configured to generate sync data in response to said audio stream and said text transcript, (ii) said sync data comprises said text transcript and a plurality of embedded timestamps, (iii) said audio processing engine is configured to generate said plurality of embedded timestamps in response to cross-referencing said text transcript to said audio stream and (iv) said sync data enables audio playback from said audio stream starting at a time of a selected one of said plurality of embedded timestamps.

13. The system according to claim 1, wherein said analytics performed by said audio processing engine are implemented by a voice recognition engine configured to (i) compare said plurality of voices with a plurality of known voices and (ii) identify portions of said audio stream that correspond to said known voices.

14. The system according to claim 1, wherein said metrics comprise key performance indicators for an employee.

15. The system according to claim 1, wherein said metrics comprise a measure of at least one of a sentiment, a speaking style and an emotional state.

16. The system according to claim 1, wherein said metrics comprise a measure of an occurrence of keywords and key phrases.

17. The system according to claim 1, wherein said metrics comprise a measure of adherence to a script.

18. The system according to claim 1, wherein said curated report is made available on a web-based dashboard interface.

19. The system according to claim 1, wherein said curated report comprises long-term trends of said metrics, indications of when said metrics are aberrant, leaderboards of employees based on said metrics and real-time notifications.

20. The system according to claim 1, wherein (i) sales data is uploaded to said server computer, (ii) said audio processing engine compares said sales data to said audio stream, (iii) said curated report summarizes correlations between said sales data and a timing of events that occurred in said audio stream and (iv) said events are detected by performing said analytics.
